(19) United States
(12) Patent Application Publication
(10) Pub. No.: US 2011/0231855 A1
(43) Pub. Date: Sep. 22, 2011

(54) APPARATUS AND METHOD FOR CONTROLLING PRIORITY

(75) Inventors: Noriaki MURATA, Yokohama (JP); Yasuo Kubota, Yokohama (JP); Naoki Akaboshi, Kawasaki (JP); Junichi Sakaguchi, Kawasaki (JP); Kazuhiro Ikemoto, Kawasaki (JP); Ken Yokoyama, Kawasaki (JP); Tamami Sugasaka, Kawasaki (JP); Taiji Sasage, Yokohama (JP); Syogo Hayashi, Kawasaki (JP)

(73) Assignee: FUJITSU LIMITED, Kawasaki-shi (JP)

(21) Appl. No.: 12/888,213

(22) Filed: Sep. 22, 2010

(30) Foreign Application Priority Data
Sep. 24, 2009 (JP) 2009-219437

(51) Int. Cl. G06F 9/46

(52) U.S. Cl. 718/103

(57) ABSTRACT

A priority control apparatus, includes a job operation information storage unit stores, as job operation information on a per job operation basis for a plurality of job operations, a process and an object used by the process with the process mapped to the object, each job operation being executed by a plurality of processes; a delay determiner determines a first job operation that is delayed from among the plurality of job operations; and a priority controller identifies a second job operation sharing an object used in the first job operation by referencing the job operation information storage unit, identifies a process, using an object not used in the first job operation, from among the processes executing the second job operation identified, and lowers a priority at which the identified process is to be executed.

### CROSS-REFERENCE TO RELATED APPLICATIONS

This application is based upon and claims the benefit of priority of the prior Japanese Patent Application No. 2009-219437, filed on Sep. 24, 2009, the entire contents of which are incorporated herein by reference.

### FIELD

The embodiments discussed herein are related to a priority control apparatus and a priority control method.

### BACKGROUND

A job operation system performing a job operation in response to a user request with a plurality of servers over a network is known. A three-layer architecture is known as an architecture for such a job operation system. The three-layer architecture includes a web server as a presentation layer, an application server as an application layer, and a database server as a data layer. A user may access the web server from the user's terminal such as a personal computer (PC) and request a desired job operation to be done. In response to the request, the job operation system performs the job operation with servers cooperating with each other.

Japanese Laid-open Patent Publication No. 2007-156796 and Japanese Laid-open Patent Publication No. 11-203149 discuss a technique in which a specific priority is set for a particular application program and application programs are executed in the order of high to low priority. Japanese Laid-open Patent Publication No. 11-242658 discusses a technique of solving a delay problem by setting a priority on application programs. International Publication 2005/041038 discusses a technique of solving a delay problem by reducing the number of processes of an application program having a low priority if a bottleneck occurs in an application server.

### SUMMARY

According to an aspect of an embodiment, a priority control apparatus includes a job operation information storage unit which stores, as job operation information on a per job operation basis for a plurality of job operations, a process and an object used by the process with the process mapped to the object, each job operation being executed by a plurality of processes; a delay determiner which determines a first job operation that is delayed from among the plurality of job operations; and a priority controller which identifies a second job operation sharing an object used in the first job operation by referencing the job operation information storage unit, identifies a process, using an object not used in the first job operation, from among the processes executing the second job operation identified, and lowers a priority at which the identified process is to be executed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example structure of a priority control apparatus of a first embodiment;

FIG. 2 illustrates an example structure of a priority control apparatus of a second embodiment;

FIGS. 3A and 3B illustrate an example of job operations;

FIG. 4 illustrates an example of a job operation information storage unit;

FIG. 5 illustrates an example of a shared use information storage unit;

FIG. 6A illustrates an example of a determination criteria storage unit;

FIG. 6B diagrammatically illustrates an example of determination criteria;

FIG. 7 illustrates an example of a determination result storage unit;

FIG. 8 illustrates an example of a delay handling information storage unit;

FIG. 9 illustrates an example of a handling result storage unit;

FIG. 10 illustrates an example of a delay handling information generator;

FIGS. 11A-11C illustrate an example of a first handling of a delayed job operation;

FIGS. 12A and 12B illustrate an example of a second handling of a delayed job operation;

FIGS. 13A and 13B illustrate the second handling of the delayed job operation by a delay handling controller;

FIG. 14 is an example flowchart of a process of the priority control apparatus of the second embodiment;

FIG. 15 is an example flowchart illustrating a determination process of the degree of delay of a job operation by the priority control apparatus of the second embodiment;

FIG. 16 is an example flowchart illustrating a handling process of a delayed job operation by the priority control apparatus of the second embodiment;

FIG. 17 is an example flowchart illustrating a first handling process of a delayed job operation by the priority control apparatus of the second embodiment;

FIG. 18 is an example flowchart illustrating a second handling process of the delayed job operation by the priority control apparatus of the second embodiment;

FIG. 19 is an example flowchart of a loop control process of the second embodiment;

FIG. 20 illustrates an example structure of a priority control apparatus of a third embodiment;

FIG. 21 illustrates an example of a degree of influence storage unit; and

FIG. 22 is an example flowchart of a loop control process according to the third embodiment

### DESCRIPTION OF EMBODIMENTS

The above-described techniques are not sufficient to solve the delay problem of the job operation. The above-described technique of processing the job operations in the order of high to low priority merely processes a particular job operation with priority, and a job operation having a low priority is not necessarily free from the delay problem. The technique of solving the delay problem with the applications prioritized is not sufficient to solve the delay problem in a job operation that is related to a low-priority application.

If a job operation having a low priority is delayed, or if a job operation related to a low-priority application is delayed, an administrator of the job operation system needs to handle the system depending on the delay.

A priority control apparatus and a priority control method of the embodiments are described below with reference to the drawings.

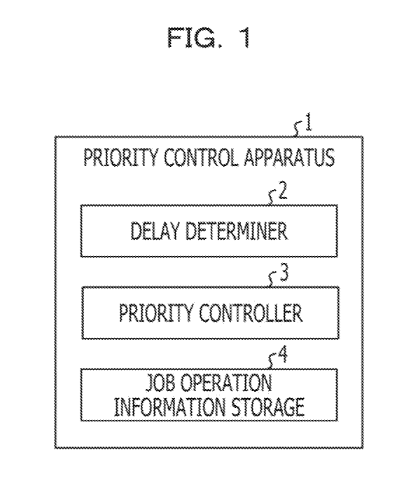

FIG. 1 illustrates an example structure of a priority control apparatus 1 of a first embodiment. Referring to FIG. 1, the priority control apparatus 1 includes a delay determiner 2, a priority controller 3, and a job operation information storage 4. The priority control apparatus 1 is connected via a network to a plurality of operation servers (not illustrated) executing a plurality of processes using objects. The plurality of operation servers cooperating with each other perform a plurality of job operations.

The job operation information storage 4 stores job operation information on a per job operation basis with each job operation executed by a plurality of processes. The job operation information includes a process executing a job operation and an object used by the process with the process respectively mapped to the object. For example, the job operation information storage 4 stores information indicating that process a1 uses object X1 and process a2 uses object X2 in job operation A. The job operation information storage 4 also stores information indicating that process b1 uses object Y1 and process a2 uses object X2 in job operation B. The job operation information storage 4 also stores information indicating that process c1 uses object Z1 and process c2 uses object Z2 in job operation C.

The delay determiner 2 determines a delayed job operation that has suffered from a delay in operation from among a plurality of job operations. For example, the delay determiner 2 determines job operation A as a delayed job operation from among job operations A, B, and C.

The priority controller 3 in a control operation thereof references the job operation information stored on the job operation information storage 4 and identifies a shared job operation as another job operation sharing an object with the delayed job operation. The priority controller 3 identifies a process using an object not used in the delayed job operation from among the processes executing the identified shared job operation, and lowers the priority of execution of the identified process. For example, the priority controller 3 identifies as the shared job operation the job operation B sharing the object X2 used in the job operation A determined as the delayed job operation. The priority controller 3 identifies the process b1 using the object Y1 not used in the job operation A as the delayed job operation from among the process b1 and the process a2 executing the job operation B identified as the shared job operation. The priority controller 3 in the control operation thereof lowers the priority of execution of the identified process b1.

In accordance with the first embodiment as described above, the priority at which the job operation B is executed is lowered, and a use rate of the process a2 in the job operation B sharing the object X2 with the job operation A is also lowered. The use rate of the process a2 in the job operation A is increased. The priority control apparatus 1 autonomously operates in response to a delay at any job operation, and thus solves the delay problem in the job operation.

The term “delayed job operation” refers to a job operation that suffers from a delay.

The term “sub delayed job operation” refers to a job operation having a degree of delay falling within a tolerance range.

The term “shared job operation” refers to another job operation sharing an object used in the delayed job operation.

The term “sub shared job operation” refers to another job operation that shares an object used in the sub delayed job operation.

The term “high shared job operation” refers to a shared job operation that has a high shared use frequency of an object in the delayed job operation and has a minimum degree of delay.

The term “priority modification process” refers to a process having an execution priority that is lowered in the job operation system.

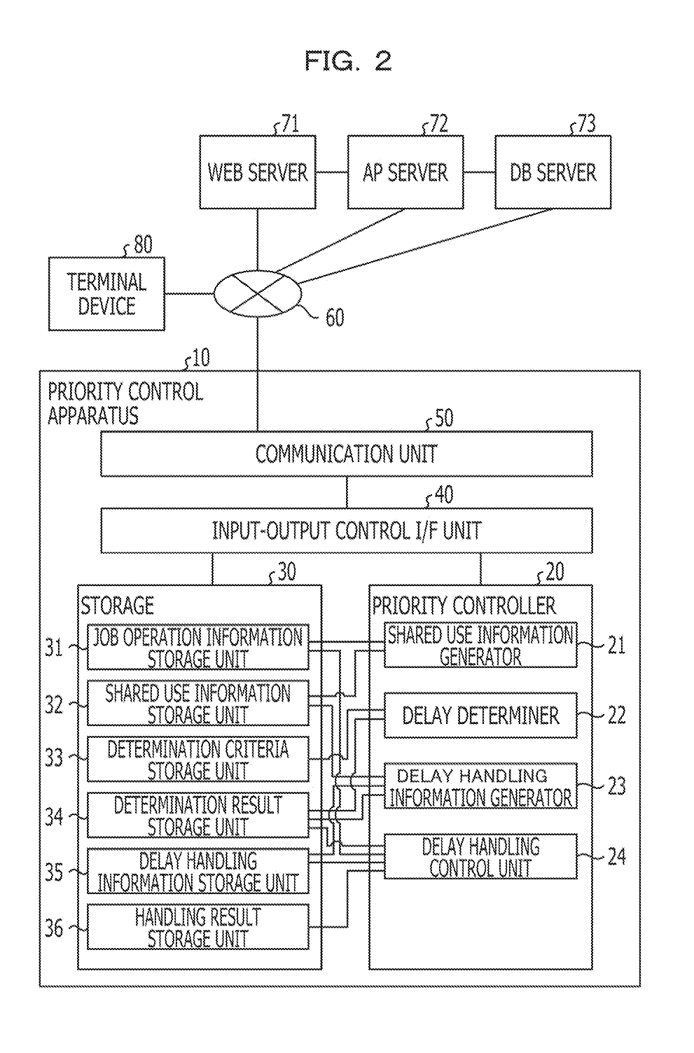

FIG. 2 illustrates an example structure of a priority control apparatus 10 of a second embodiment.

The priority control apparatus 10 includes priority controller 20, storage 30, input-output control I/F (interface) unit 40, and communication unit 50. The priority control apparatus 10 is connected to a Web server 71, an AP server 72, and a DB server 73 via a network 60.

A terminal device 80 transmits via the network 60 an execution request of a job operation to a job operation system including the Web server 71, the AP server 72, and the DB server 73. The priority control apparatus 10 monitors a process status of the job operation executed by the job operation system.

The Web server 71 is a Web server, the AP server 72 is an application server, and the DB server 73 is a database server. Referring to FIG. 2, the single terminal device 80 is illustrated. In practice, a plurality of terminal devices 80 may be connected to the network 60.

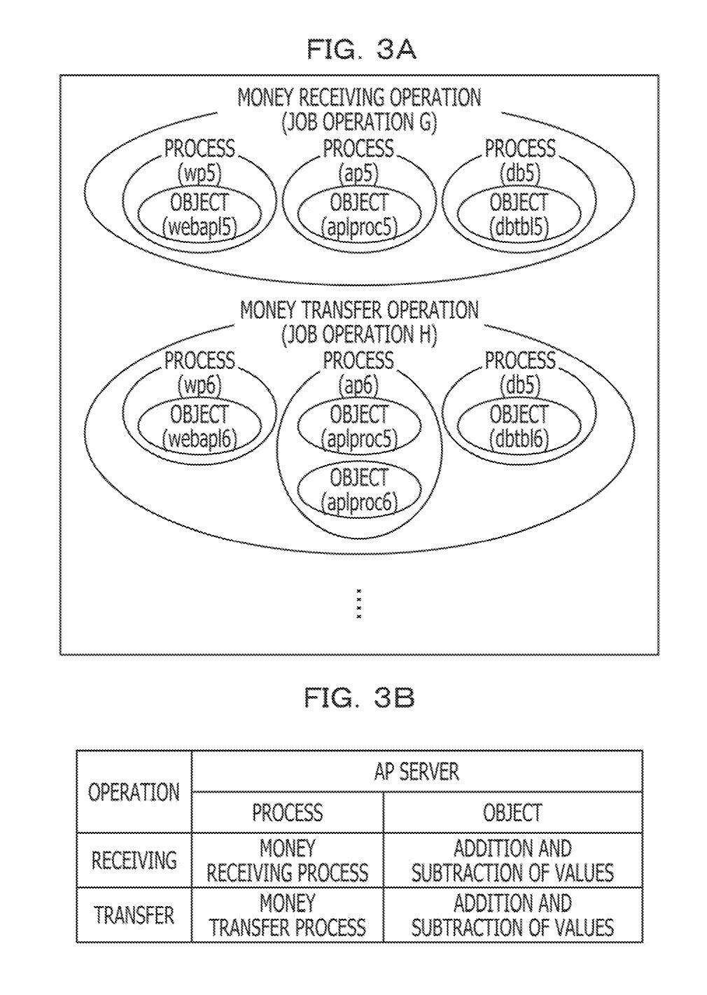

FIGS. 3A and 3B illustrate an example of job operations. For example, job operations performed by the Web server 71, the AP server 72, and the DB server 73 in cooperation include a money receiving operation (job operation G) and a money transfer operation (job operation H) requested by a user through an automated teller machine (ATM) in a bank as illustrated in FIG. 3A. Each server performs these job operations by executing a process responsive to each job operation using an object.

The money receiving operation (job operation G) is described below with reference to FIG. 3A.

The Web server 71 performs a process (wp5) using an object (webapl5). For example, the Web server 71 displays a money receiving operation on a screen of the ATM, and receives money from a user.

The AP server 72 performs a process (ap5) using an object (aplproc5). For example, the AP server 72 performs an addition operation of a received amount of money on an account the user inputs.

The DB server 73 performs a process (db5) using an object (dbtbl5). For example, the DB server 73 records a balance of the account after the money is received.

The money transfer operation (job operation H) illustrated in FIG. 3A is described.

The Web server 71 performs a process (wp6) using an object (webapl6), thereby presenting a money transfer operation on the screen and performing a money receiving operation.

The AP server 72 performs a process (ap6) using the object (aplproc5) and the object (aplproc6), thereby performing the money transfer operation.

The DB server 73 performs the process (db5) using an object (dbtbl6), thereby recording a balance of an account as a transfer destination after the money transfer.

The objects used by the process performed in the Web server 71 include a variety of information displayed on the screen of the ATM and operation trail. The objects used by the process performed by the AP server 72 includes a variety of application programs and log files. The objects used by the process performed by the DB server 73 include a database of accounts of a bank. The objects may be stored on a read-only memory (ROM), a random-access memory (RAM), or a hard disk.

If job operations performed on the same server are similar to each other in the job operation system, an object such as the object (aplproc5) illustrated in FIG. 3A may be shared among different job operations. For example, to perform the money receiving operation, the AP server 72 performs a “money receiving process” to add a received amount of money to the balance of an account using, as an object, a program (aplproc5) that performs addition and subtraction of values as illustrated in FIG. 3B. To perform the money transfer operation, the AP server 72 subtracts a transfer amount of money from a transfer source account and adds the transfer amount of money to the balance of a destination transfer account using, as the object, program (aplproc5).

A single process may use a plurality of objects in the job operation of the job operation system (see, for example, the process (ap6) in FIG. 3A). The same process may use different objects in the job operations of the Web server 71, the AP server 72, and the DB server 73 (see, for example, the process (db5) in FIG. 3A).

Referring back to FIG. 2, the network 60 relays data to be exchanged between the priority control apparatus 10 and each of the Web server 71, the AP server 72, and the DB server 73, and data to be exchanged between the terminal device 80 and each of the Web server 71. For example, the network 60 is a local-area network (LAN), a wide-area network (WAN), or the like.

The Web server 71 presents via the network 60 a variety of job operations on the terminal device 80 to be discussed later. The Web server 71 receives an execution request of a job operation desired by a user, and performs an operation responsive to the received execution request. The WEB server 71 sends to the AP server 72 the received execution request of the job operation and a variety of information input by the user. The Web server 71 sends to the terminal device 80 results of the job operation performed in cooperation with the AP server 72 and the DB server 73.

The AP server 72 performs an application in response to the execution request of the job operation received from the Web server 71 and the variety of information input by the user and sends the operation results to the DB server 73. The DB server 73 stores the operation results received from the AP server 72 onto a storage device thereof.

The terminal device 80 serves as a device on which the user inputs an execution request to the job operation system. For example, the terminal device 80 may be one of a personal computer (PC), a workstation, a cellular phone, a personal handy-phone system (PHS), a personal digital assistant (PDA) owned by the user, or an automated teller machine (ATM) at a bank.

The input-output control I/F unit 40 is an interface relaying a variety of information to be exchanged between the communication unit 50 and each of the priority controller 20 and the storage 30. The communication unit 50 communicates with each of the Web server 71, the DB server 73, and the DB server 73.

The storage 30 stores programs and data for a variety of operations performed by the priority controller 20 to be discussed later. The storage 30 also stores information received from the Web server 71, the AP server 72, and the DB server 73 and operation results of an operation controlled by the priority controller 20. The storage 30 may be a storage device such as a random-access memory (RAM), a read-only memory (ROM), a flash memory, a semiconductor memory, a hard disk, or an optical disk. As illustrated in FIG. 2, the storage 30 includes job operation information storage unit 31, shared use information storage unit 32, determination criteria storage unit 33, determination result storage unit 34, delay handling information storage unit 35, and handling result storage unit 36.

The job operation information storage unit 31 stores job operation information on a per job operation basis, each job operation executed by a plurality of processes. The job operation information includes a process executing a job operation, and an object used by the process with the process mapped to the object. For example, a job operation information acquisition apparatus (not illustrated) acquires from each server a process on a per job operation basis, the process being performed by each server when the job operation is performed. The object is used by the process. The job operation information acquisition apparatus may be a switching hub having a port mirroring function that outputs communication contents on a network to another communication path. Alternatively, the job operation information acquisition apparatus may be an agent that is arranged in each server to monitor the server and report the process of the server.

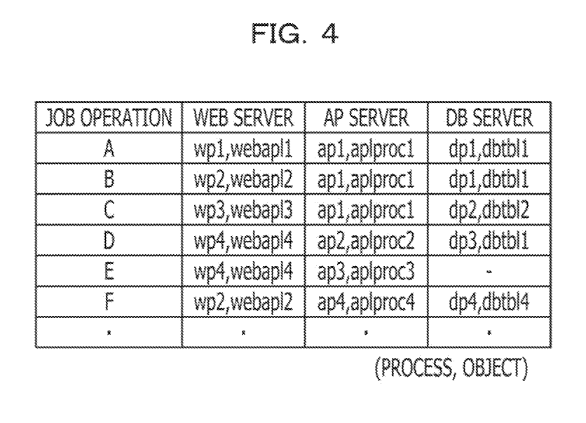

FIG. 4 illustrates an example of the job operation information storage unit 31. As illustrated in FIG. 4, the job operation information storage unit 31 stores a process and an object, executed by each server, in a mapped state on a per job operation basis. For example, as illustrated in FIG. 4, the job operation information storage unit 31 stores job operation information “job operation: A Web server: (wp1, webapl1), AP server: (ap1, aplproc1), DB server: (db1, dbtbl1).” Each server is represented in a designation (process, object). When a job operation is performed at each server, the designation represents the process executed by the server and the object used by the server. Similarly, the job operation information storage unit 31 stores, for each of the job operations B-F, the process executed by each of the Web server 71, the AP server 72, and the DB server 73 and the object used in the process with the process mapped to the object. The “DB server” for the “job operation E” in FIG. 4 indicates that the “job operation E” is a job operation in which the DB server is not used.

The shared use information storage unit 32 stores shared use information that that maps to each job operation a shared use frequency of an object shared by another job operation. The shared use information stored on the shared use information storage unit 32 is generated by the priority controller 20 to be discussed later.

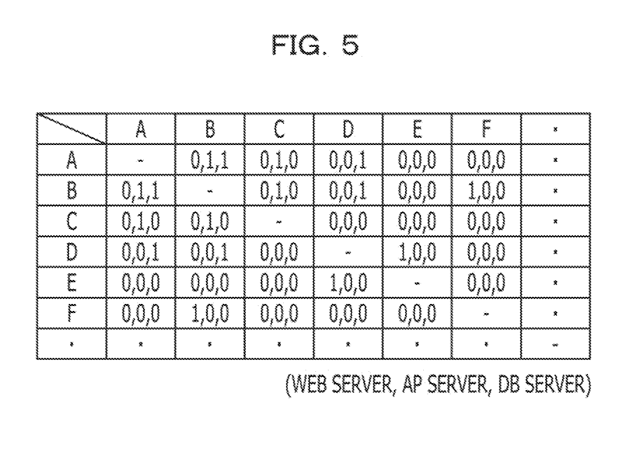

FIG. 5 illustrates an example of the shared use information storage unit 32. As illustrated in FIG. 5, the shared use information storage unit 32 stores the shared use information mapped to each job operation. As illustrated in FIG. 5, the shared use information storage unit 32 stores “(Web server, AP server, DB server): (0,1,1)” as the shared use information of the “job operation: B” to the “job operation: A.” The values of the shared use information indicate a shared use frequency of an object among the servers. For example, a shared use frequency of “1” indicates that one object is shared by the job operations, and a shared use frequency of “0” indicates that no object is shared by the job operations. In the above example, the “job operation A” and the “job operation B” have no shared relationship in the Web server 71, and have a shared relationship in the AP server 72 and the DB server 73.

As illustrated in FIG. 5, the shared use information storage unit 32 stores the shared use frequencies of the “job operation: A” with each of the “job operations: B-F,” of the “job operation: B” with each of the “job operations: A and C-F,” and of the “job operation: C” with each of the “job operations: A, B and D-F.” Similarly, the shared use information storage unit 32 stores the shared use frequencies of the “job operation: D” with each of the “job operations: A-C, E, and F,” of the “job operation: E” with each of the “job operations: A-D and F,” and of the “job operation: F” with each of the “job operations: A-E.” The dash mark “-” indicates no shared use information.

The determination criteria storage unit 33 stores determination criteria indicating a degree of delay and mapped to each job operation. The determination criteria stored on the determination criteria storage unit 33 is information of a range of a process time of a job operation, set by the user of the priority control apparatus 10. The determination criteria are used by the priority controller 20 to be discussed later.

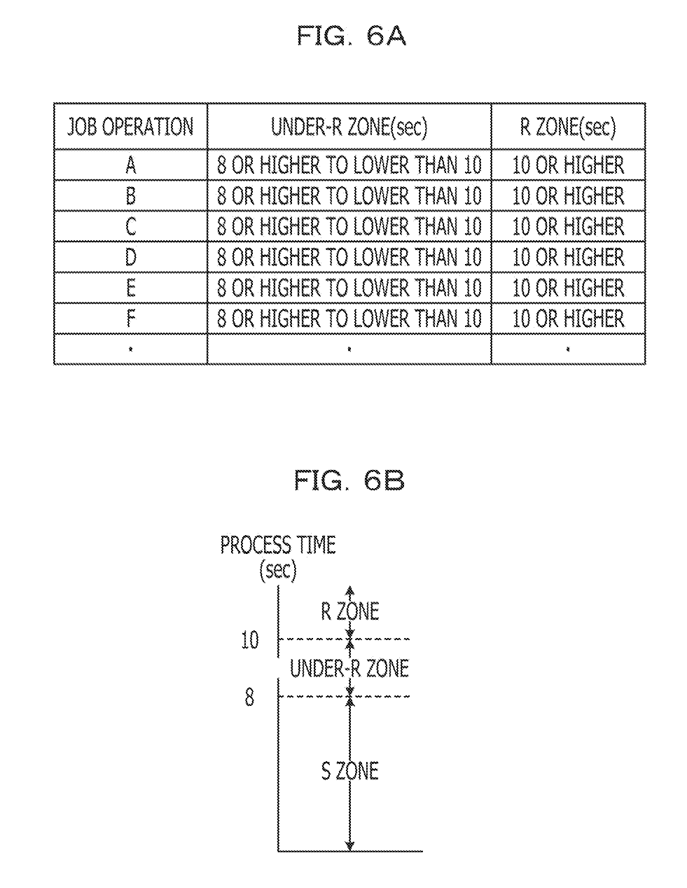

FIG. 6A illustrates an example of determination criteria. As illustrated in FIG. 6A, the determination criteria storage unit 33 stores the determination criteria that map a criterion indicating an under-R zone (seconds) and a criterion indicating an R zone on a per job operation basis. The “under-R zone” refers to a criterion of a tolerance range within which the degree of delay of the job operation is tolerable. The “R zone” refers to a criterion at which the degree of delay of the job operation is high with the job operation suffering from a delay.

FIG. 6B diagrammatically illustrates the determination criteria. The user of the priority control apparatus 10 sets a process time of 10 seconds or longer to be the R zone, a process time of 8 seconds or longer to shorter than 10 seconds to be the under-R zone, and a process time of shorter 8 seconds to be an S zone.

Referring to FIG. 6A, the determination criteria storage unit 33 stores determination criteria “under-R zone (seconds): 8 or longer to shorter than 10, R zone (seconds): 10 or longer” mapped to the “job operation: A.” The determination criteria storage unit 33 also stores the determination criteria “under-R zone (seconds): 8 or longer to shorter than 10, R zone (seconds): 10 or longer” mapped to the “job operations: B-F” as illustrated in FIG. 6A. The “S zone” refers to a criterion free from delay. The process time of the job operation defining the zones is not limited to the above-described times. The user of the priority control apparatus 10 may set any process time to the job operation.

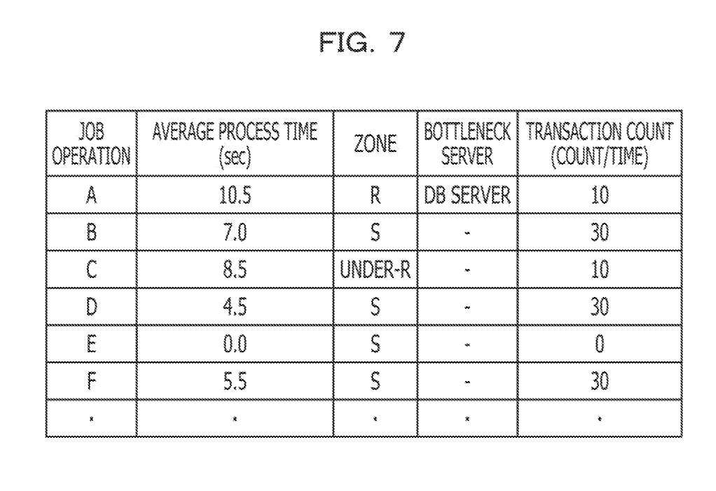

The determination result storage unit 34 stores determination results that map the job operation information received from the job operation information acquisition apparatus (not illustrated) to the process results of the determination process of the priority controller 20. FIG. 7 illustrates an example of the determination result storage unit 34. As illustrated in FIG. 7, the determination result storage unit 34 stores the determination results that map average process time (seconds), a zone, a bottleneck server, and a transaction count (count/time) in a mutually mapped state. The “average process time” is an average of process times of job operations executed, and the “bottleneck server” refers to a server that is a cause of a delay in the job operation. The “transaction count (count/time)” refers to the number of job operations performed per unit time. These pieces of information are received from the job operation information acquisition apparatus (not illustrated). The “zone” refers to a degree of delay of the job operation determined by the priority controller 20 to be discussed later.

As illustrated in FIG. 7, the determination result storage unit 34 stores the determination results “average process time (seconds): 10.5, zone: R, bottleneck server: DB server, transaction count (count/time): 10” mapped to the “job operation: A.” Similarly as illustrated in FIG. 7, the determination result storage unit 34 stores the determination results “average process time, zone, bottleneck server, transaction count (count/time)” mapped to each of the “job operations: B-F.” The “average process time: 0.0” and the “transaction count: 0” for the “job operation: E” indicate that the job operation E is not executed yet. The “bottleneck server:-” represents that there is no bottleneck server.

The average process time, the information as to the bottleneck server, and the transaction count (count/time) from the job operation information acquisition apparatus may be obtained using a technique discussed in Japanese Laid-open Patent Publication No. 2006-92358, a technique discussed in Japanese Laid-open Patent Publication No. 2006-11683, and a technique discussed in Japanese Laid-open Patent Publication No. 2007-272693.

The delay handling information storage unit 35 stores, on a per job operation basis, delay handling information that maps to each job operation a shared use frequency of an object shared by the delayed job operation in each server. The delay handling information stored on the delay handling information storage unit 35 is generated by the priority controller 20 to be discussed later.

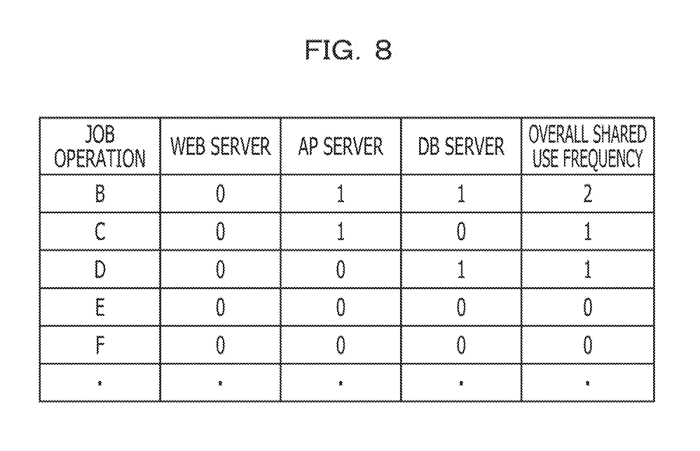

FIG. 8 illustrates an example of the delay handling information storage unit 35. As illustrated in FIG. 8, the delay handling information storage unit 35 stores on a per job operation basis the delay handling information that maps the shared use frequency of the job operation in each of the Web server, the AP server, and the DB server to the overall shared use frequency. The “shared use frequency” refers to a shared relationship of each object with the delayed job operation at each server, and the “overall shared use frequency” refers to the degree of sharing of the object with the delayed job operation.

As illustrated in FIG. 8, for example, the delay handling information storage unit 35 stores the delay handling information “Web server: 0, AP server: 1, DB server: 1, overall shared use frequency: 2” mapped to the “job operation: B.” Shared between the delayed job operation and the “job operation: B” in this example are “0” object in the Web server 71, “1” object in the AP server 72, and “1” object in the DB server 73. The overall shared use frequency is “2”. Similarly, the delay handling information storage unit 35 stores the shared use frequency at each of the “job operations: C-F” mapped to the overall shared use frequency.

The handling result storage unit 36 stores results of the handling to the delay executed by the priority controller 20. The handling results stored on the handling result storage unit 36 are information generated by the priority controller 20.

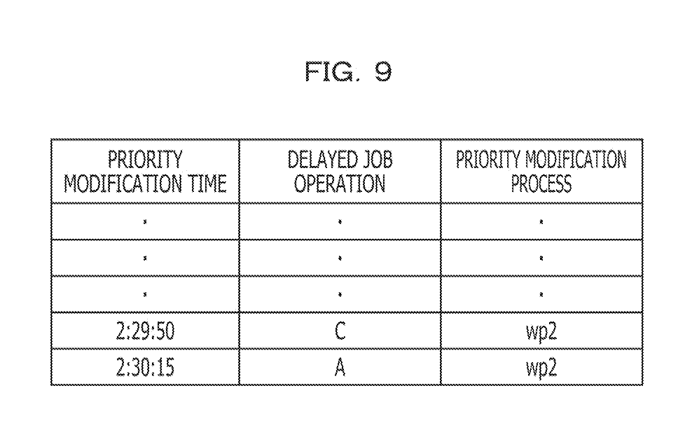

FIG. 9 illustrates the handling result storage unit 36. As illustrated in FIG. 9, the handling result storage unit 36 stores the handling results including priority modification time, delayed job operation, and priority modification process in a mapped state. The “priority modification time” represents time at which the priority controller 20 has performed a control operation thereof. The “delayed job operation” represents a job operation that has undergone a delay handling operation. The “priority modification process” represents a process having a priority thereof lowered.

As illustrated in FIG. 9, for example, the handling result storage unit 36 stores handling results “priority modification time: 2:29:50, delayed job operation: C, priority modification process: wp2.” This example means that the priority of the “process: wp2” in the “delayed job operation: C” was lowered at “time: 2:29:50.” Also as illustrated in FIG. 9, the handling result storage unit 36 stores handling results “priority modification time: 2:30:15, delayed job operation: A, priority modification process: wp2.”

Referring back to FIG. 2, the priority controller 20 includes an internal memory storing a program defining a variety of operation procedures and specific data, and then executes a variety of processes in accordance with the programs and data. The priority controller 20 controls a delayed job operation handling to solve a delay caused in a job operation. The priority controller 20 may be an integrated circuit such as an application specific integrated circuit (ASIC), or a field programmable gate array (FPGA), or an electronic circuit such as a central processing circuit (CPU) or a micro processing unit (MPU). As illustrated in FIG. 2, the priority controller 20 includes shared use information generator 21, delay determiner 22, delay handling information generator 23, and delay handling control unit 24.

In accordance with the job operation information stored on the job operation information storage unit 31, the shared use information generator 21 generates the shared use information mapping to a job operation a shared use frequency of an object shared with another job operation on a per job operation basis. The shared use information generator 21 then stores the generated shared use information onto the shared use information storage unit 32. For example, the shared use information generator 21 generates the shared use information that maps information of an object shared with another job operation to each server on a per job operation basis, and stores the generated shared use information onto the shared use information storage unit 32.

The shared use information generator 21 references the job operation information of FIG. 4, generates the shared use information of FIG. 5, and stores the generated shared use information onto the shared use information storage unit 32. Shared between the “job operation: A” and the “job operation: B,” for example, are objects in the AP server 72 and the DB server 73. The shared use information generator 21 generates the shared use information (0,1,1) and then stores the shared use information (0,1,1) on the shared use information storage unit 32.

The delay determiner 22 determines a job operation suffering from a delay from among a plurality of job operations. For example, the delay determiner 22 compares the determination criteria stored on the determination criteria storage unit 33 with the job operation information received from the job operation information acquisition apparatus (not illustrated), determines the degree of delay of all the job operations executed, and stores determination results on the determination result storage unit 34.

The delay determiner 22 may now receive from the job operation information acquisition apparatus (not illustrated) the job operation information “job operation: A, average process time: 10.5, transition count (count/time): 10.” Since the average process time is longer than 10 seconds, the delay determiner 22 determines according to the determination criteria of FIG. 6A that the “job operation: A” as a delayed job operation is in the R zone. The delay determiner 22 then stores the determination results on the determination result storage unit 34. As illustrated in FIG. 7, the delay determiner 22 determines the degrees of delay of the “job operations: B-F” and stores on the determination result storage unit 34 the determination results mapped to the zone of each job operation.

The delay determiner 22 further determines a cause area serving as a main cause of delay from among a plurality of execution areas through which a process of the job operation determined as the delayed job operation is performed. For example, the delay determiner 22 identifies a server taking the longest process time from among the servers performing the delayed job operation, based on the job operation information received from the job operation information acquisition apparatus (not illustrated). The delay determiner 22 thus determines the identified server as a bottleneck server. The delay determiner 22 then stores on the determination result storage unit 34 the bottleneck server mapped to the determination results.

For example, the process time of the “DB server” may be the longest among the process times of the servers received from the job operation information acquisition apparatus (not illustrated). The delay determiner 22 determines the bottleneck server of the “job operation: A” as the “DB server.” The delay determiner 22 maps the “DB server” to the determination results and then stores these pieces of information in a mapped state on the determination result storage unit 34. For example, the delay determiner 22 stores on the determination result storage unit 34 the determination results with the “bottleneck server” of the “job operation: A” set to be the “DB server.”

For a job operation that is not delayed, the delay determiner 22 stores “bottleneck server: -” indicating that there is no bottleneck server. For example, the delay determiner 22 stores on the determination result storage unit 34 the determination results that the “bottleneck server” of the “job operation: B” is “-,” as illustrated in FIG. 7. Similarly, the delay determiner 22 stores on the determination result storage unit 34 the determination results that the “bottleneck servers” of the “job operations: C-F” are “-,” as illustrated in FIG. 7.

The delay handling information generator 23 identifies a shared job operation that shares an object used in the delayed job operation, and generates information that identifies a process using an object not used in the delayed job operation from among the processes executing the identified shared job operation. For example, using the shared use information stored on the shared use information storage unit 32, and the determination results stored on the determination result storage unit 34, the delay handling information generator 23 generates delay handling information as the information for identifying the process, and stores the generated delay handling information on the delay handling information storage unit 35.

For example, the delay handling information generator 23 generates, as the delay handling information for the “job operation: A,” “job operation: B, Web server: 0, AP server: 1, DB server: 1, shared use frequency: 2” as illustrated in FIG. 8. Similarly, the delay handling information generator 23 generates the delay handling information of the “job operations: C-F” with respect to the “job operation: A” as illustrated in FIG. 8.

The delay handling information generator 23 further generates delay handling information related to the object which is used by the process executed in an area determined by the delay determiner 22 as the cause area serving as a main cause for delay and which is weighted with a specific weight from among the shared job operations. For example, the delay handling information generator 23 updates the delay handling information stored on the delay handling information storage unit 35 by weighting the object shared in the bottleneck server of the delayed job operation with a specific weight.

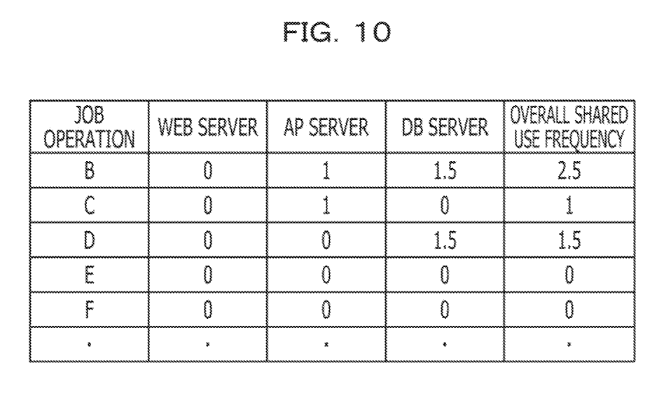

FIG. 10 illustrates an example of the delay handling information generator 23. If “1.5” is stored as a specific weight on the storage 30, the delay handling information generator 23 updates the delay handling information by multiplying by “1.5” the object shared in the “DB server” as the “bottleneck server” of the “job operation: A.” For example, the delay handling information generator 23 updates the delay handling information of the “job operation: B” illustrated in FIG. 8 to the delay handling information “job operation: B, Web server: 0, AP server: 1, DB server: 1.5, overall shared use frequency: 2.5” illustrated in FIG. 10.

Similarly, the delay handling information generator 23 updates the delay handling information of the “job operation: D” illustrated in FIG. 8 to the delay handling information “job operation: D, Web server: 0, AP server: 0, DB server: 1.5, overall shared use frequency: 2.5” as illustrated in FIG. 10. The delay handling information of a job operation having no object shared in the “DB server” as a bottleneck server is not updated and stored as is. For example, the delay handling information of the “job operation: C” is not updated, and stored as the delay handling information “job operation: C, Web server: 0, AP server: 1, DB server: 0, overall shared use frequency: 1” as illustrated in FIG. 10. Similarly, the delay handling information “job operation: E, Web server: 0, AP server: 0, DB server: 0, overall shared use frequency: 0” and the delay handling information “job operation: F, Web server: 0, AP server: 0, DB server: 0, overall shared use frequency: 0” are stored as is without being updated (see FIG. 10).

Using the variety of information and operation results stored on the memory units, the priority control apparatus 10 of the embodiment performs a first handling and a second handling to the delayed job operation to solve the delay of the delayed job operation. The first handling of the delayed job operation is described first followed by the discussion of the second handling of the delayed job operation.

In the first handling of the delayed job operation, the delay handling control unit 24 identifies the shared job operation sharing an object used in the delayed job operation by referencing the job operation information stored on the job operation information storage unit 31. The delay handling control unit 24 further identifies as a high shared job operation a job operation having a high shared use frequency with the delayed job operation and having a minimum degree of delay, from among the shared job operations. The delay handling control unit 24 further identifies, from among the shared job operations, a high shared job operation by referencing the shared use information after the shared use frequency of an object used by a process executed in the cause area determined by the delay determiner 22 is weighted with a specific weight.

For example, the delay handling control unit 24 identifies the shared job operation sharing the object with the delayed job operation by referencing the delay handling information stored on the delay handling information storage unit 35. The delay handling control unit 24 references the delay handling information having the weighted shared use frequency of the object shared in the bottleneck server and also references the determination results stored on the determination result storage unit 34. The delay handling control unit 24 identifies as the high shared job operation with priority a job operation in the S zone and having a high shared use frequency.

For example, the delay handling control unit 24 identifies as a high shared job operation the “job operation: B” having a maximum shared use frequency of “2.5” as illustrated in FIG. 10 and in the S zone in the determination results of FIG. 7.

The delay handling control unit 24 further identifies as a control target a process from among the processes to be executed in the identified high shared job operation. For example, the delay handling control unit 24 identifies a process using an object not used in the delayed job operation from among the processes executing the identified high shared job operation. For example, in the delay handling information of FIG. 10, the delay handling control unit 24 identifies from the job operation information of FIG. 4 the process executed in the “Web server” having a shared use frequency of “0” mapped to the “job operation: B”. In other words, the delay handling control unit 24 identifies the process “wp2.”

The delay handling control unit 24 in a control operation thereof lowers the priority of the identified process. For example, the delay handling control unit 24 sends to a server executing the identified process a command to lower the priority of the identified process. For example, the delay handling control unit 24 sends to the Web server 71 a command to lower the priority at which the identified process “wp2” is executed.

Since a server having a shared use frequency of “0” is only the “Web server,” “wp2” is identified. If a plurality of servers have a shared use frequency of “0,” a higher layered server is preferably selected in the three-layered job operation system.

As described above, the delay handling control unit 24 solves the delay of the job operation through the first handling of the delayed job operation, in which the priority of the process of the high shared job operation corresponding to the delayed job operation is lowered. For example, the delay handling control unit 24 solves the delay of the job operation by varying a ratio of an object shared by a plurality of job operations.

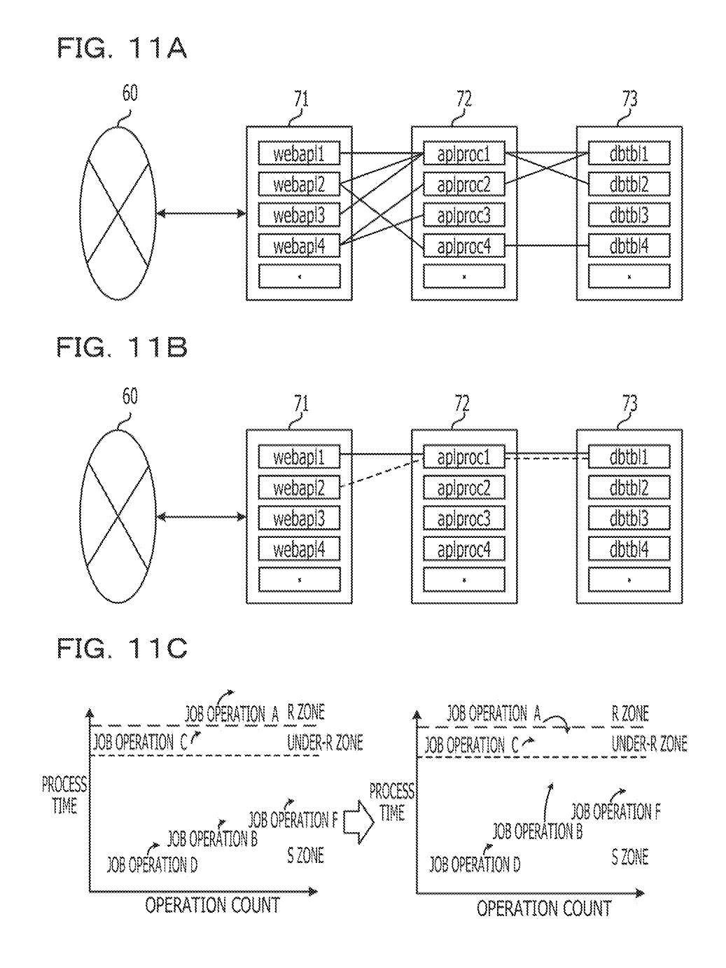

FIGS. 11A-11C illustrate the first handling of the delayed job operation by the delay handling control unit 24. The object used in each job operation of FIG. 4 is stored in each of the Web server 71, the AP server 72, and the DB server 73 as illustrated in FIG. 11A, and is used in a job operation requested via the network 60. The job operation system including the Web server 71, the AP server 72, and the DB server 73 executes the “job operation: A” using “webapl1,” “aplproc1,” and “dbtbl1” linked through the servers. The job operation system executes the “job operation: B” using “webapl2,” “aplproc1,” and “dbtbl1” linked through the servers. Similarly, the job operation system executes the “job operations: C-F” using the objects of FIG. 4 over each server illustrated in FIG. 11A.

The delay handling control unit 24 of the embodiment lowers the priority of the process using an object not used in the delayed job operation from among the processes executed in the high shared job operation, thereby lowering the process speed of the high shared job operation and lowering the ratio of the use of the object. For example, of the object shared by the delayed job operation and the high shared object operation, the delay handling control unit 24 lowers the ratio of use of the object in the high shared object operation. The delay handling control unit 24 thus increases the ratio of use of the object in the delayed job operation, thereby solving the delay problem.

Referring to FIG. 11B, the delay handling control unit 24 lowers the ratio of use of a process using “webapl2” not used in the “job operation: A,” thereby lowering the process speed of the “job operation: B” linked by broken lines. As a result, the ratio of use of “aplproc1” in the “job operation: B” decreases, and the ratio of use of “aplproc1” in the “job operation: A” increases. The process speed of the “job operation: A” denoted by solid lines in FIG. 11B increases.

Referring to FIG. 11C, the delay handling control unit 24 lowers the process speed of the job operation B in the S zone, thereby increasing the process speed of the job operation A in the R zone, and shifting the job operation A to the under-R zone. As illustrated in FIG. 11C, the job operations C, D and F remain unchanged in process speed. The vertical line of the graph of FIG. 11C represents process time, and the horizontal line represents operation count.

In the second handling of the delayed job operation, if the high shared job operation is determined as a sub delayed job operation, the delay handling control unit 24 references the job operation information and identifies as a high shared job operation a sub shared job operation sharing an object used in the sub delayed job operation. For example, if no shared job operation is in the S zone, the delay handling control unit 24 references delay handling information newly generated for a shared job operation having a highest shared use frequency with the delayed job operation and determination results. The delay handling control unit 24 identifies as a target of priority modification a job operation having a highest shared use frequency and in the S zone, from among the job operations sharing an object with the shared job operation having the highest shared use frequency with the delayed job operation.

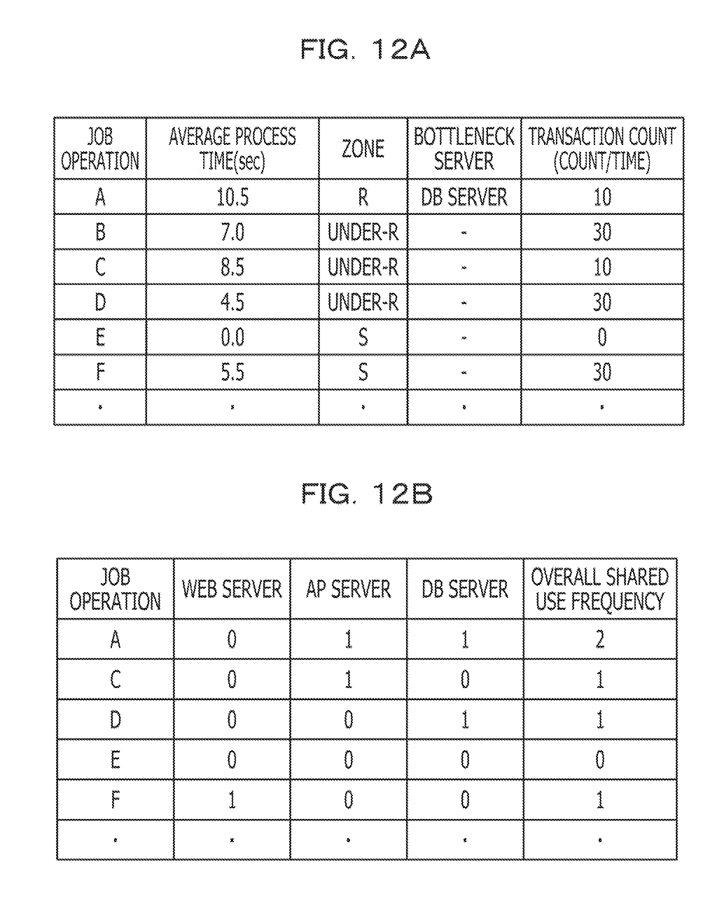

FIGS. 12A and 12B illustrate examples of the second handling of the delayed job operation by the priority control apparatus of the second embodiment. In contrast to the determination results of FIG. 7, the determination results of FIG. 12A include the “job operations: B-D” set to be in the “under-R zone” and the delay handling information of the “job operation: B” is newly generated as the delay handling information of FIG. 12B. In such a case, the delay handling control unit 24 references the delay handling information of FIG. 12B and the determination results of FIG. 12A and identifies as a job operation as a target of priority modification the “job operation: F” in the S zone from among the “job operations: A, C, D, F” having an overall shared use frequency of 1 or higher.

The delay handling control unit 24 then identifies a process using an object not used in a shared job operation having the highest shared use frequency with the delayed job operation, from among the processes executed in the identified job operation. For example, the delay handling control unit 24 references the job operation information and identifies a process “ap4” using an object “aplproc4” not used in the “job operation: B” as a target process of priority modification in the identified “job operation: F.”

The delay handling control unit 24 in the control operation thereof lowers the priority of the identified process. For example, the delay handling control unit 24 sends to a server executing the identified process a command to lower the priority of the identified process. For example, the delay handling control unit 24 sends to the AP server 72 a command to lower the priority at which the identified process “ap4” is executed.

As described above, the delay handling control unit 24 solves a delay of a job operation through the second handling of the delayed job operation. In the second handling of the delayed job operation, the delay handling control unit 24 lowers the priority of the process of the sub shared job operation to the shared job operation as the sub delayed job operation. For example, the delay handling control unit 24 shifts the shared job operation from the under-R zone to the S zone, thereby enabling the first handling to the delayed job operation to be performed. The delay handling control unit 24 thus solves the delay problem of the delayed job operation.

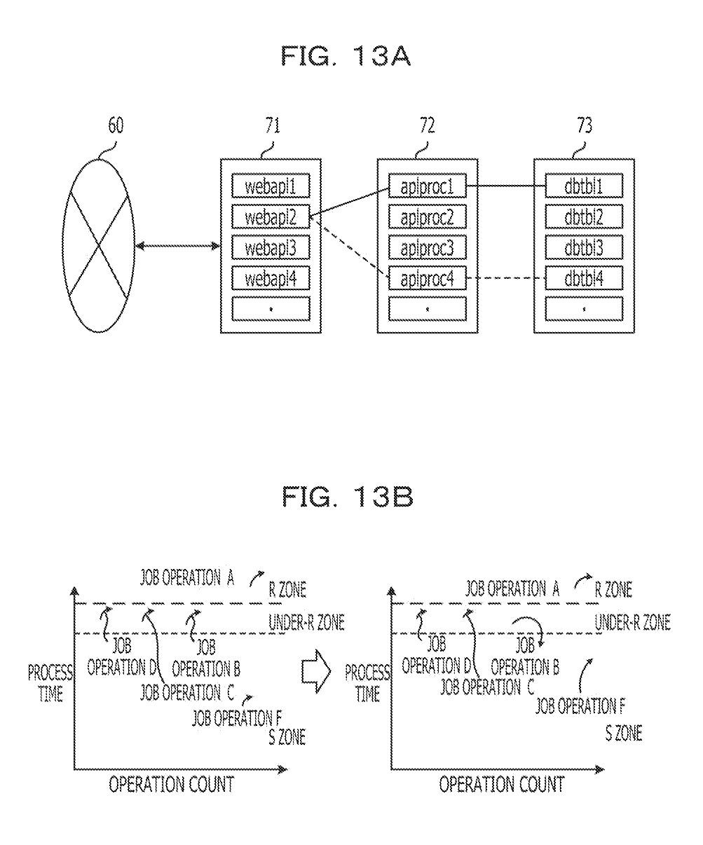

FIGS. 13A and 13B illustrate an example of the second handling of the delayed job operation by the delay handling control unit 24. As illustrated in FIG. 13A, the AP server 72 lowers the priority of a process using “aplproc4” not used in the “job operation: B”, thereby lowering the process speed of the “job operation: F” linked by broken lines. This operation lowers the ratio of use of “webapl2” in the “job operation: F” and raises the ratio of use of “webapl2” in the “job operation: B” in the Web server 71. The process speed of the “job operation: B” denoted by solid lines increases as illustrated in FIG. 13A.

For example, the delay handling control unit 24 lowers the process speed of the job operation F in the S zone as illustrated in FIG. 13B, thereby increasing the process speed of the job operation B in the under-R zone and thereby shifting the job operation B into the S zone. If the delay problem is solved by increasing the process speed of the job operation B, a new first handling is not needed for the job operation A as a delayed job operation. The process speeds of the job operation C and the job operation D remain unchanged as illustrated in FIG. 13B. In the graph of FIG. 13B, the vertical line represents process time and the horizontal line represents operation count.

If the priority of a particular process has been lowered in connection with the same job operation before, the delay handling control unit 24 in the control operation thereof lowers the priority of the process on condition that a specific period of time has elapsed since the time of lowering the priority. For example, each time the handling of the delayed job operation is executed, the delay handling control unit 24 stores on the handling result storage unit 36 handling results that map the priority modification time to the delayed job operation and the priority modified process. When the delay handling control unit 24 performs newly the handling of the delayed job operation, the delay handling control unit 24 lowers the priority only if the same delayed job operation and the priority modification process are not stored within the specific period of time on the handling result storage unit 36.

For example, the delay handling control unit 24 stores on the handling result storage unit 36 “priority modification time: 2:29:50, delayed job operation: C, priority modification process: wp2” as illustrated in FIG. 9. The delay handling control unit 24 also stores on the handling result storage unit 36 “priority modification time: 2:30:15, delayed job operation: A, priority modification process: wp2” as illustrated in FIG. 9.

The delay handling control unit 24 references the handling results of FIG. 9 and detection time band preset by the user before newly lowering the priority of the “process: wp2” to the “delayed job operation: A.” For example, 60 (seconds) as the detection time band is stored on the storage 30. The delay handling control unit 24 lowers the priority of “wp2” only if the priority of the “process: wp2” has not been lowered to the “delayed job operation: A” during 60 seconds up to the present time. For example, if the present time is “2:31:15” or later, the delay handling control unit 24 in the control operation thereof newly lowers the priority of “wp2” to the “delayed job operation: A.”

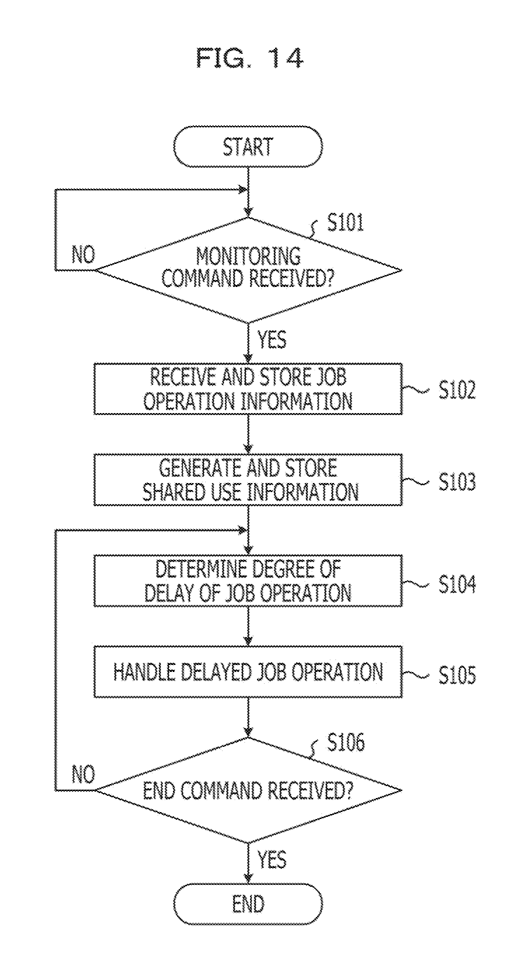

FIG. 14 is an example flowchart of a process of the priority control apparatus of the second embodiment.

Referring to FIG. 14, if the priority control apparatus 10 of the second embodiment receives a monitoring command from a user (yes branch at S101), the priority controller 20 receives the job operation information and stores the received job operation information on the job operation information storage unit 31 (at S102). For example, the priority controller 20 stores the job operation information on the job operation information storage unit 31 on a per job operation basis. The job operation information includes a process executing the job operation, an object used by the process, and a server on which the process is executed with the process, the object, and the server mapped to each other.

On a per job operation, the shared use information generator 21 generates the shared use information that maps information of an object shared with another job operation to the other job operation. The shared use information generator 21 stores the generated shared use information on the shared use information storage unit 32 (at S103).

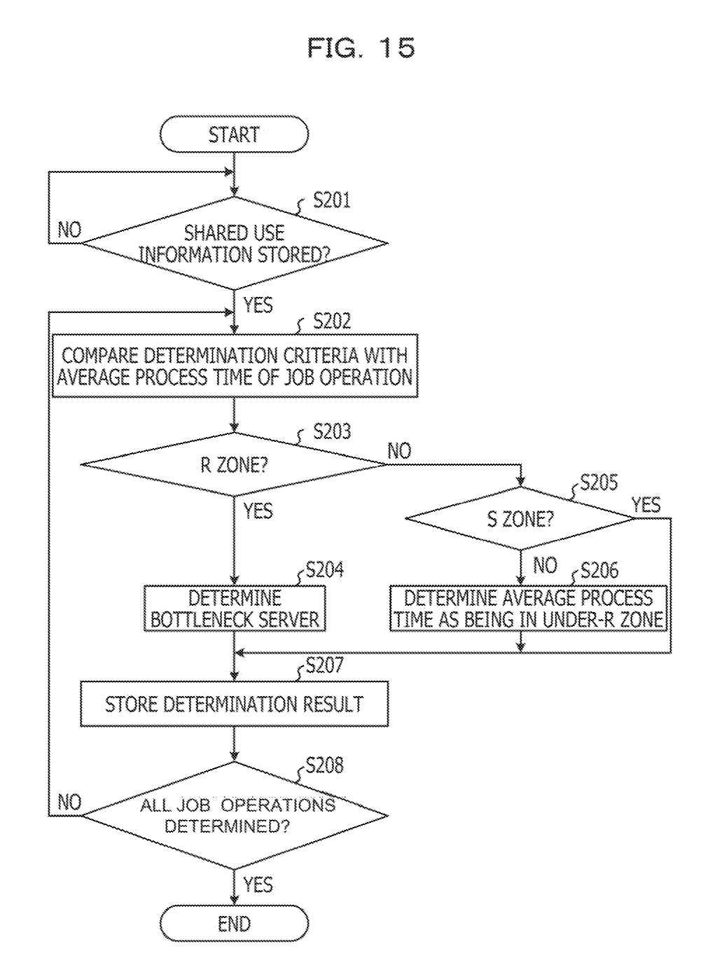

The delay determiner 22 compares the determination criteria stored on the determination criteria storage unit 33 with the average process time of each job operation received from the communication unit 50, and determines the degree of delay of the job operation (at S104). The determination process of the degree of delay is described in detail later with reference to FIG. 15.

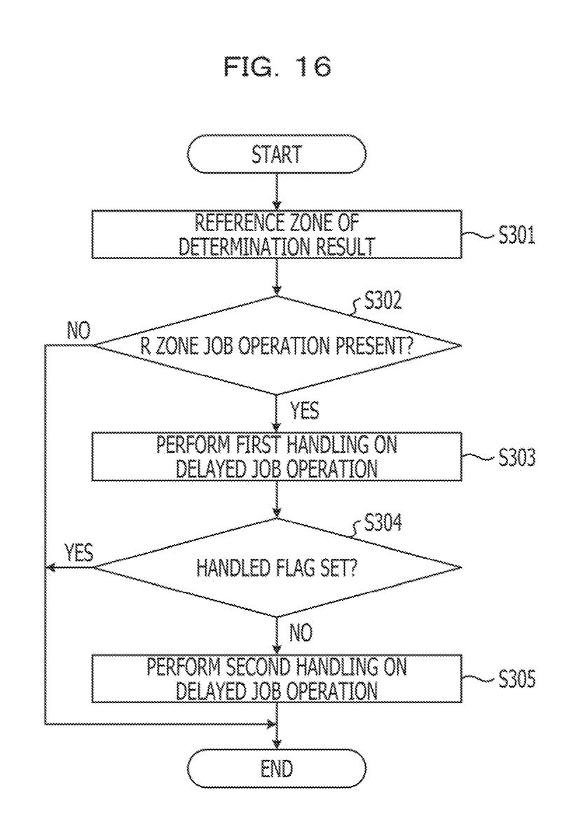

The delay handling control unit 24 executes the handling of the delayed job operation that is determined by the delay determiner 22 (at S105), and determines whether an end command has been received (at S106). The process of the handling of the delayed job operation is described in detail later with reference to FIGS. 16-18.

If the delay handling control unit 24 at S106 that the end command has not been received from the user (no branch from S106), the delay determiner 22 returns to S104. The delay determiner 22 compares the determination criteria with the average process time of the job operations newly received from the communication unit 50 and determines the degree of delay of the job operation.

If the delay handling control unit 24 determines at S106 that the end command has been received from the user (yes branch from S106), the priority control apparatus 10 of the second embodiment ends the process.

The determination process of the degree of delay of the job operation executed at S104 of FIG. 14 is described below. FIG. 15 is an example flowchart of a determination process of determining the degree of delay of the job operation by the priority control apparatus 10 of the second embodiment.

If the priority control apparatus 10 of the second embodiment stores the shared use information (yes branch from S201) in FIG. 15, the delay determiner 22 compares the determination criteria with the average process time (at S202). The delay determiner 22 determines whether the average process time of the job operation is in the R zone (at S203). For example, upon receiving the average process time of a variety of job operations from the job operation information acquisition apparatus, the delay determiner 22 determines whether the received average process time is in the R zone of the delayed job operation set according to the determination criteria.

If it is determined that the average process time is in the R zone (yes branch from S203), the delay determiner 22 determines a bottleneck server of the job operation that is in the R zone based on time for a process received from the job operation information acquisition apparatus (at S204). For example, the delay determiner 22 determines one of the Web server 71, the AP server 72, and the DB server 73 having the longest time for processing as a bottleneck server.

If the average process time is not in the R zone (no branch from S203), the delay determiner 22 determines whether the received average process time is in the S zone set in the determination criteria (at S205). If the average process time is not in the S zone (no branch from S205), the delay determiner 22 determines that the average process time is in the under-R zone (at S206).

The delay determiner 22 stores the determination results on the determination result storage unit 34 (at S207). For example, the delay determiner 22 stores the determination results on the determination result storage unit 34 on a per job operation basis. The determination results include the average process time, the determined zone, the bottleneck server, and the transaction count mapped to each other. The information related to the average process time, and the bottleneck server and the transaction count is acquired from the job operation information acquisition apparatus (not illustrated).

The delay determiner 22 determines whether all the job operations have been determined (at S208). If not all the job operations have been determined (no branch from S208), the delay determiner 22 returns to S202 to compare the determination criteria with the average process time of the job operation. If all the job operations have been determined (yes branch from S208), the delay determiner 22 ends the determination process.

The handling of the delayed job operation executed at S105 of FIG. 14 is described. FIG. 16 is an example flowchart of the handling process of the delayed job operation by the priority control apparatus 10 of the second embodiment.

Referring to FIG. 16, the priority control apparatus 10 of the second embodiment completes the determination process at S104 of FIG. 14. The delay handling information generator 23 references the determination results (at S301). The delay handling information generator 23 determines whether a job operation in the R zone is present in the determination results (at S302).

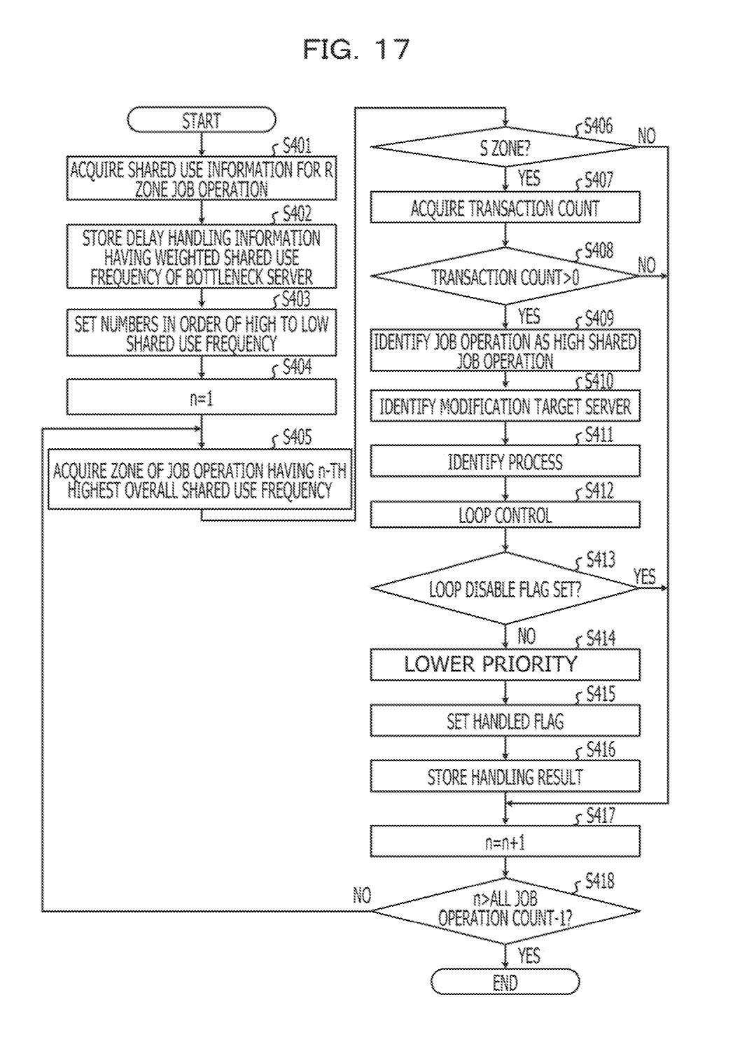

If no R zone job operation is present (no branch from S302), the priority control apparatus 10 of the second embodiment ends the process thereof. If an R zone job operation is present (yes branch from S302), the delay handling control unit 24 performs the first handling of the delayed job operation (at S303). The first handling of the delayed job operation is described in detail with reference to FIG. 17.

The delay handling control unit 24 determines whether a handled flag is set (at S304). For example, the handled flag is set if the first handling of the delayed job operation is performed. The timing of setting the handled flag is described later.

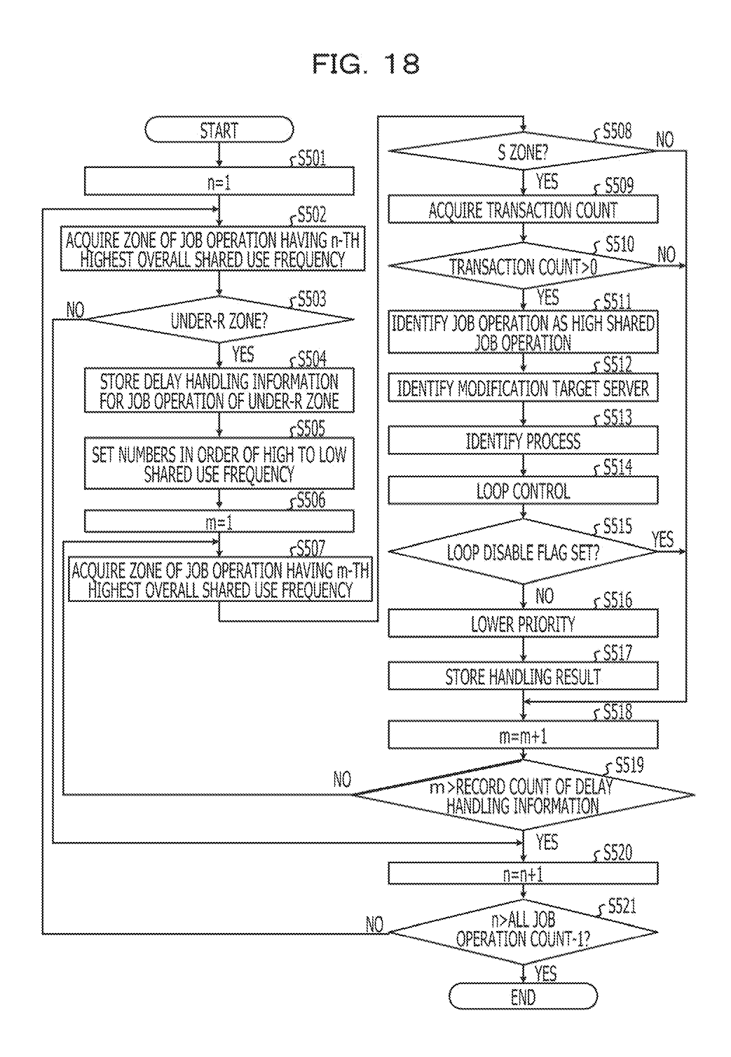

If the handled flag is set (yes branch from S304), the delay handling control unit 24 completes the process thereof. If the handled flag is not set (no branch from S304), the delay handling control unit 24 executes the second handling of the delayed job operation (at S305), and completes the process thereof. The second handling of the delayed job operation is described later with reference to FIG. 18.

The first handling of the delayed job operation executed at S303 of FIG. 16 is described below. FIG. 17 is an example flowchart of the first handling of the delayed job operation of the priority control apparatus 10 of the second embodiment.

Referring to FIG. 17, if the priority control apparatus 10 of the second embodiment determines in S302 of FIG. 16 that an R zone job operation is present, the delay handling information generator 23 acquires the shared use information for the R zone job operation (at S401). The delay handling information generator 23 generates the delay handling information with the weighted shared use frequency of the bottleneck server, stores the delay handling information on the delay handling information storage unit 35 (at S402), and attaches numbers in the order of high to low overall shared use frequency (at S403).

The delay handling control unit 24 sets the number n for the overall shared use frequency to be n=1 based on the delay handling information (at S404), and acquires the zone of the job operation having the n-th highest overall shared use frequency (at S405). For example, the delay handling control unit 24 acquires from the determination result storage unit 34 the zone of the job operation having the highest overall shared use frequency. The delay handling control unit 24 determines whether the acquired zone is in the S zone (at S406).

If it is determined that the acquired zone is the S zone (yes branch from S406), the delay handling control unit 24 acquires the transaction count of the job operation determined as being in the S zone (at S407), and determines whether the transaction count is higher than “0” (at S408). For example, the delay handling control unit 24 determines whether the job operation is a job operation currently in progress.

If it is determined at S408 that the transaction count is higher than “0” (yes branch from S408), the delay handling control unit 24 identifies as the high shared job operation the job operation in the S zone (at S409) and identifies the modification target server (at S410). For example, the delay handling control unit 24 identifies as the modification target server a server executing a process using an object not used in the delayed job operation, from among the processes executing the job operation identified as the high shared job operation.

The delay handling control unit 24 identifies a process that executes the high shared job operation in the identified modification target server (at S411). For example, the delay handling control unit 24 references the job operation information stored on the job operation information storage unit 31, thereby identifying the process executing the high shared job operation in the identified modification target server.

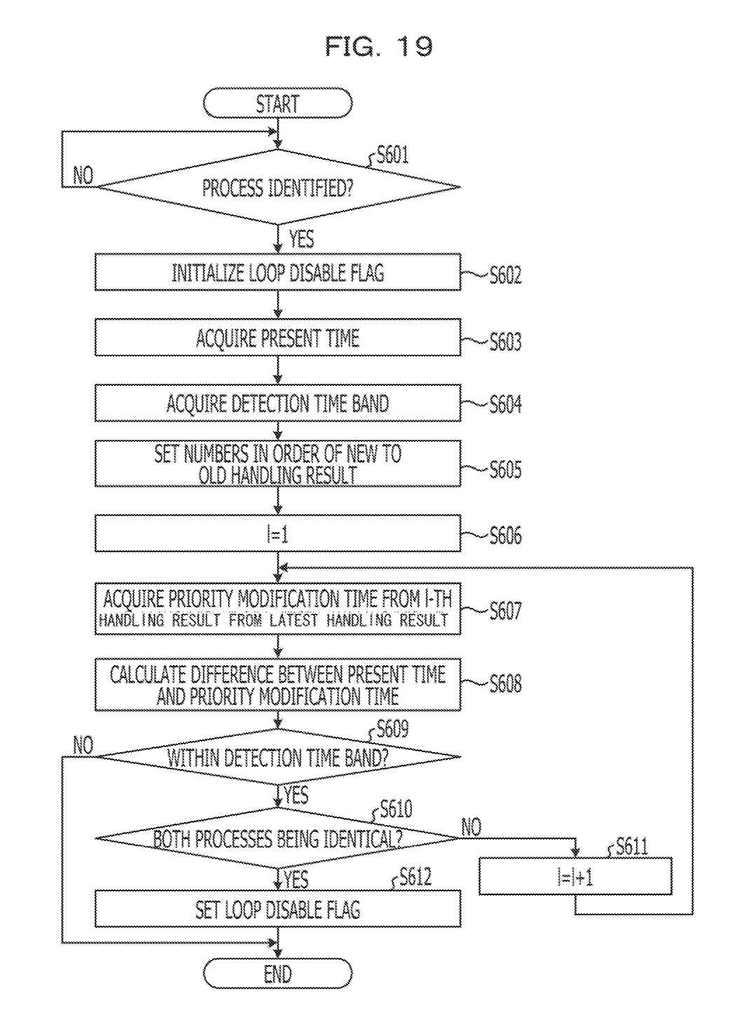

The delay handling control unit 24 performs a loop control process that prevents the priority modification being repeated in the same combination of the delayed job operation and the priority modification process (at S412). The control loop process is described in detail later with reference to FIG. 19.

The delay handling control unit 24 determines whether a loop disable flag is set (at S413). For example, the delay handling control unit 24 determines whether the priority of the identified high shared job operation has been lowered within a specific period of time in the same combination of the delayed job operation and the priority modification process.

Upon determining at S413 that the loop disable flag is not set (no branch from S413), the delay handling control unit 24 in the control operation thereof lowers the priority of the process identified at S411 (at S414). For example, the delay handling control unit 24 then sends to the modification target server a command to lower the priority of the identified process.

The delay handling control unit 24 sets a handled flag indicating that the handling of the delayed job operation has been executed (at S415). For example, the delay handling control unit 24 stores on the handling result storage unit 36 the handled flag that is information indicating that the first handling of the delayed job operation has been executed.

The delay handling control unit 24 then stores on the handling result storage unit 36 the handling results including the priority modification time, the delayed job operation, and the priority modification process mapped to each other (at S416). In accordance with the delay handling information, the delay handling control unit 24 sets the number n, set for the overall shared use frequency to, n=n+1 (at S417). The delay handling control unit 24 executes the handling of a job operation having the second highest shared use frequency.

Similarly, upon determining at S406 that the job operation is not in the S zone (no branch at S406), the delay handling control unit 24 sets the number n, set for the shared use frequency in accordance with the delay handling information, to n=n+1 (at S417). Upon determining at S408 that the transaction count is not higher than “0” (no branch from S408), the delay handling control unit 24 sets the number n, set for the overall shared use frequency in accordance with the delay handling information, to n=n+1 (at S417). Upon determining at S413 that the loop disable flag is set (yes branch from S413), the delay handling control unit 24 sets the number n, set for the overall shared use frequency in accordance with the delay handling information, to n=n+1 (at S417).

The delay handling control unit 24 then determines whether n is greater than a value that results from subtracting 1 from the overall transaction count (at S418). In other words, the delay handling control unit 24 determines whether the first handling has been performed on all the job operations other than the delayed job operation.

Upon determining that n is not greater than a value that results from subtracting 1 from all the transaction count (no branch from S418), the delay handling control unit 24 returns to S405 to acquire the zone of the job operation having the second highest shared use frequency (at S405). Upon determining that n is greater than a value that results from subtracting 1 from all the transaction count (no branch from S418), the delay handling control unit 24 ends the process thereof (yes branch from S418).

The second handling of the delayed job operation executed at S305 of FIG. 16 is described below. FIG. 18 is an example flowchart of the second handling of the delayed job operation by the priority control apparatus 10 of the second embodiment. S508-S517 in FIG. 18 are respectively similar to S406-S414 and S416 in FIG. 17, and the detailed discussion thereof is omitted here.

If the priority control apparatus 10 of the second embodiment determines at S304 of FIG. 16 that the handled flag is not set, the delay handling control unit 24 sets the number n, set in the order of high to low overall shared use frequency, to n=1 (at S501).

The delay handling control unit 24 acquires the zone of the job operation having the n-th highest overall shared use frequency (at S502), and determines whether the zone is the under-R zone (at S503). For example, the delay handling control unit 24 acquires the zone of the job operation having the highest overall shared use frequency and determines whether the zone is the under-R zone.

If it is determined at S503 that the zone acquired is the under-R zone (yes branch from S503), the delay handling information generator 23 generates the delay handling information for the job operation in the under-R zone and stores the generated delay handling information on the delay handling information storage unit 35 (at S504). The delay handling information generator 23 attaches numbers to the overall shared use frequencies in the order of high to low overall shared use frequency (at S505). The delay handling control unit 24 sets the number m, set in the order from high to low overall shared use frequency, to m=1 (at S506).

The delay handling control unit 24 acquires the zone of a job operation having the m-th highest overall shared use frequency (at S507) and determines whether the acquired zone is the S zone (at S508). For example, the delay handling control unit 24 acquires the zone of the job operation having the highest overall shared use frequency and determines whether the acquired zone is the S zone. As in S406-S414 of FIG. 17, the delay handling control unit 24 then determines the transaction count, identifies the high shared job operation, identifies the process, performs the loop control process, and performs the priority lowering control process (at S508-S516).

To identify a process at S513, the delay handling control unit 24 identifies a process that does not execute a currently delayed job operation. For example, to identify at S513 a process having the priority thereof to be lowered, the delay handling control unit 24 identifies, as a process with the priority thereof to be lowered, a process not executed in a job operation currently in the R zone.

After the priority of the process identified at S516 is lowered, the delay handling control unit 24 stores the handling results on the handling result storage unit 36 as in a similar manner as at S416 of FIG. 17 (at S517).

In accordance with the delay handling information, the delay handling control unit 24 sets the number m, set for the overall shared use frequency, to m=m+1 (at S518). For example, the delay handling control unit 24 performs the control operation thereof on the job operation having the next highest shared use frequency. Similarly, upon determining at S508 that the job operation is not in the S zone (no branch from S508), the delay handling control unit 24 sets the number m, set for the overall shared use frequency, to m=m+1 (at S518). Upon determining at S510 that the transaction count is not higher than “0” (no branch from S510), the delay handling control unit 24 sets the number m, set for the overall shared use frequency in accordance with the delay handling information, to m=m+1 (at S518). Upon determining at S515 that the loop disable flag is set (yes branch from S515), the delay handling control unit 24 sets the number m, set for the overall shared use frequency in accordance with the delay handling information, to m=m+1 (at S518).

The delay handling control unit 24 determines whether m is greater than the record count of delay handling information (at S519). For example, the delay handling control unit 24 determines whether the second handling of the delayed job operation is executed on all the job operations in the under-R zone.

Upon determining that m is not greater than the record count of delay handling information (no branch from S519), the delay handling control unit 24 returns to S507 to acquire the zone of a job operation having the next highest shared use frequency (at S507). Upon determining that m is greater than the record count of delay handling information (yes branch from S519), the delay handling control unit 24 sets the number n, set for the overall shared use frequency of the shared job operation to the delayed job operation, to n=n+1 (at S520). Similarly, upon determining at S503 that the zone is not the under-R zone, the delay handling control unit 24 sets the number n, set for the overall shared use frequency of the shared job operation to the delayed job operation, to n=n+1 (at S520). The delay handling control unit 24 then determines whether n is greater than a value that results from subtracting 1 from the overall job operation count (at S521).

Upon determining at S521 that n is not greater than a value that results from subtracting 1 from the overall job operation count (no branch from S521), the delay handling control unit 24 returns to S502 to acquire the zone of a job operation having the next high share use frequency (at S502). Upon determining at S521 that n is greater than a value that results from subtracting 1 from the overall job operation count (yes branch from S521), the delay handling control unit 24 ends the process thereof.

The loop control process executed at S412 in FIG. 17 and at S514 in FIG. 18 is described below. FIG. 19 is an example flowchart illustrating the loop control process of the second embodiment.

Referring to FIG. 19, if the priority control apparatus 10 of the second embodiment identifies the process the priority of which is to be lowered (yes branch from S601), the delay handling control unit 24 initializes the loop disable flag (at S602). For example, the delay handling control unit 24 deletes the loop disable flag that was stored on the storage 30 in response to the previously executed loop control process.

The delay handling control unit 24 acquires the present time (at S603), and acquires the detection time band stored on the storage 30 (at S604). The delay handling control unit 24 sets numbers to the handling results stored on the handling result storage unit 36 in the order of new to old results (at S605).

The delay handling control unit 24 sets the number l, set for the handling result, to l=1 (at S606), and acquires the priority modification time from the 1-th handling result of the latest handling results (at S607). The delay handling control unit 24 calculates a difference between the present time and the priority modification time (at S608), and determines whether the calculated difference is within the detection time band (at S609).

Upon determining that the difference is not within the detection time band (no branch from S609), the delay handling control unit 24 ends the process thereof. Upon determining that the difference is within the detection time band (yes branch from S609), the delay handling control unit 24 determines whether the process of the delayed job operation and the high shared job operation are similar to the process of the delayed job operation having undergone the delay handling before and the priority modification process (at S610). For example, the delay handling control unit 24 determines whether the identified process of the high shared job operation and the delayed job operation are similar to the priority modification process mapped to the priority modification time acquired at S607 and the delayed job operation.

Upon determining at S610 that the process of the delayed job operation and the high shared job operation are similar to the process of the delayed job operation having undergone the delay handling before and the priority modification process (no branch from S610), the delay handling control unit 24 sets the number l, set for the handling result, to l=l+1 (at S611). The delay handling control unit 24 then returns to S607 to acquire the priority modification time from the (l+1)-th handling result (at S607). In other words, the delay handling control unit 24 acquires the priority modification time of the next newest handling result.

Upon determining at S610 that the process of the delayed job operation and the high shared job operation are similar to the process of the delayed job operation having undergone the delay handling before and the priority modification process (yes branch from S610), the delay handling control unit 24 sets the loop disable flag (at S612), and ends the process thereof. For example, the delay handling control unit 24 stores on the storage 30 the loop disable flag indicating that the priority of the same process has been modified with the detection time band, and then ends the process thereof.

In accordance with the second embodiment as described above, the job operation information storage unit 31 stores the job operation information that maps on a per job operation basis the process executing the job operation and the object used by the process with each job operation executed by a plurality of processes. The delay determiner 22 determines the delayed job operation that is delayed in operation from among the plurality of job operations. The priority controller 20 references the job operation information stored on the job operation information storage unit 31 and identifies the shared job operation that is another job operation sharing the object used in the delayed job operation. The priority controller 20 in the control operation thereof identifies the process using the object not used in the delayed job operation, from among the processes executing the identified shared job operation, and lowers the priority at which the identified process is to be executed. The priority control apparatus 10 responds autonomously in response to a delay of any job operation, and solves the delay problem.

The identified process may have the priority that has been lowered in response to the same delayed object operation before. In accordance with the second embodiment, the priority controller 20 in the control operation thereof lowers the priority of the identified process on condition that a specific period of time has elapsed since the time of lowering the priority. This arrangement prevents the priority from being modified repeatedly in the same job operation and lightens the load of lowering the priority.

In accordance with the second embodiment, the shared use information storage unit 32 stores on a per job operation basis the shared use information that maps the shared use frequency of the object shared in another job operation to each job operation. The delay determiner 22 determines the degree of delay generated in the job operation. The priority controller 20 references the shared use information and identifies as the high shared job operation from the shared job operations the job operation having a high shared use frequency with the delayed job operation and having a minimum degree of delay determined by the delay determiner 22. The priority controller 20 in the control operation thereof identifies the process using the object not used in the delayed job operation, from among the processes executing the identified high shared job operation, and lowers the priority of the identified process. A job operation having a high effectiveness to delay solving and having a minimum effect on priority lowering can thus be selected, and the delaying of the job operation is solved even further.

In accordance with the second embodiment, the shared use information storage unit 32 stores the shared use frequency of the shared use information with the execution area of the process mapped thereto. The delay determiner 22 determines the cause area serving as the main cause of delay in a plurality of execution areas on which the process of the job operation determined as the delayed job operation is executed. The priority controller 20 determines from the shared use information storage unit 32 the shared use frequency of the object used by the process executed in the cause area determined by the delay determiner 22 with respect to the delayed job operation. The priority controller 20 identifies the high shared job operation by referencing the shared use information having the identified shared use frequency weighted with a specific weight, and identifies the process using the object not used in the delayed job operation, from among the processes executing the identified high shared job operation. The priority controller 20 in the control operation thereof lowers the priority of the identified process. The job operation sharing the object in the bottleneck server is identified with priority, and the delay is effectively solved. The delaying of the job operation is even further effectively solved.

In accordance with the second embodiment, the delay determiner 22 sorts the job operations other than the delayed job operation into a sub delayed job operation having the degree of delay falling within a specific tolerance range, and a no-delay job operation that is free from delay, and then determines the job operations. If the delay determiner 22 determines the high shared job operation as a no-delay job operation, the priority controller 20 in the control operation thereof lowers in the high shared job operation the priority of the process using the object not used in the delayed job operation. If the high shared job operation is determined as a sub delayed job operation, the priority controller 20 references the job operation information stored on the job operation information storage unit 31 and identifies as a high shared job operation the sub shared job operation sharing the object used in the sub delayed job operation. In the high shared job operation, the priority controller 20 in the control operation thereof lowers the priority of the process using the object not used in the sub delayed job operation. Even if the high shared job operation is a sub delayed job operation, the delay of the delayed job operation is solved without lowering the priority of the sub delayed job operation. The bad effect of lowering the priority is minimized.

In accordance with the second embodiment, the priority of the same process is not lowered on the same delayed job operation within the specific period of time in the loop control process of the delay handling control unit 24. In accordance with a third embodiment, the loop control process accounts for the operation count in addition to the specific period of time as conditions thereof.

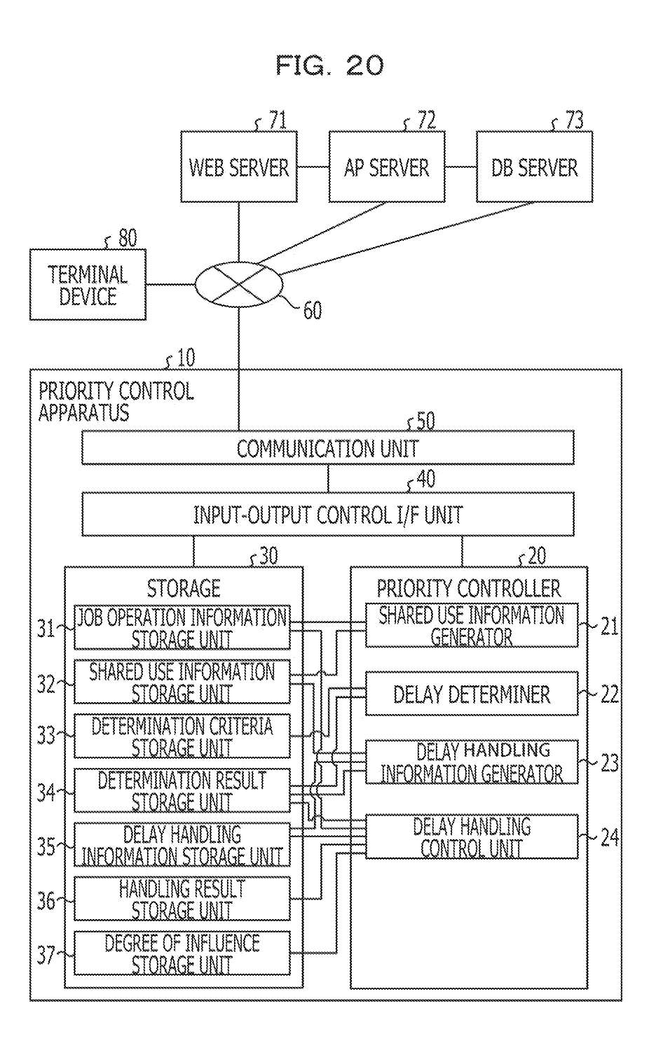

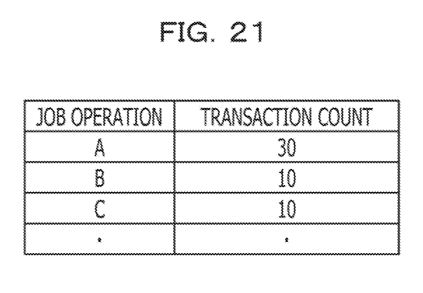

An example structure of a priority control apparatus 10 of the third embodiment is described with reference to FIGS. 20 and 21. FIG. 20 illustrates the structure of the priority control apparatus 10 of the third embodiment. The priority control apparatus 10 of the second embodiment is different from the priority control apparatus of the third embodiment illustrated in FIG. 20 in that the priority control apparatus of the third embodiment includes a degree of influence storage unit 37 and is different in the process content of the delay handling control unit 24. The difference is mainly described below.

The degree of influence storage unit 37 stores degree of influence information that maps the present operation count to each job operation. The priority controller 20 generates and updates the degree of influence information stored on the degree of influence storage unit 37 in response to a transaction count per job operation acquired from the job operation information acquisition apparatus (not illustrated) as appropriate. FIG. 21 illustrates an example of information stored on the degree of influence storage unit 37. As illustrated in FIG. 21, the degree of influence storage unit 37 stores the degree of influence information that maps the job operation to the transaction count. In FIG. 21, the “job operation” refers to a job operation executed by each of the Web server 71, the AP server 72, and the DB server 73, and the “transaction count” refers to the number of currently processed jobs. For example, the degree of influence storage unit 37 stores the degree of influence information “job operation: A, transaction count: 30” as illustrated in FIG. 21. For example, in this example, the number of currently processed jobs “transaction count” is “30” at the “job operation: A.” Similarly, the degree of influence storage unit 37 stores the degree of influence information “job operation: B, transaction count: 10” and the degree of influence information “job operation: C, transaction count: 10.”

If the process currently executing the delayed job operation has the priority that has been lowered before, the delay handling control unit 24 identifies the job operation having a currently processed job count larger than that of the delayed job operation. The delay handling control unit 24 determines whether the priority of the process has been lowered with respect to the identified job operation. If the priority has been lowered, the delay handling control unit 24 lowers the priority of the identified process on condition that a specific period of time has elapsed since the time of lowering of the priority.

When a handling of the delayed job operation is newly executed, the delay handling control unit 24 determines whether a process of executing a currently delayed job operation (hereinafter referred to as a delayed job process) within a specific period of time is stored on the handling result storage unit 36. Only if the delay handling control unit 24 determines that the delayed job process within the specific period of time is stored on the handling result storage unit 36, the delay handling control unit 24 references the degree of influence storage unit 37. The delay handling control unit 24 then compares the transaction count of the currently delayed job operation with the current transaction count of the job operation stored on the handling result storage unit 36 and mapped to the delayed job process. Only if the current transaction count of the job operation stored and mapped to the delayed job process is higher than the transaction count of the currently delayed job operation, the delay handling control unit 24 sets the loop disable flag. If the delayed job process within the specific period of time is not stored on the handling result storage unit 36 in the execution of the new handling of the delayed job operation, the delay handling control unit 24 in the control operation thereof lowers the priority of the identified process. If it is determined that the delayed job process within the specific period of time is stored, and if the current transaction count of the job operation mapped to the delayed job process is lower than the transaction count of the delayed job operation, the delay handling control unit 24 in the control operation thereof lowers the priority.

For example, the present time may be “2:31:00,” 60 seconds may be stored as the detection time band on the storage 30, and the priority of the “process: wp1” may be newly lowered with respect to the “delayed job operation: B.” In such a case, the delay handling control unit 24 references the handling result storage unit 36 and determines whether the priority of the process executing the “job operation: B” within the detection time band has been lowered. If none of the processes “wp2, ap1, db1” executing the “job operation: B” are stored within the specific period of time on the handling result storage unit 36, the delay handling control unit 24 in the control operation thereof lowers the priority of the “process: wp1” with respect to the “delayed job operation: B.”

If the process “wp2” executing “B” within the detection time band is stored as illustrated in FIG. 9, the delay handling control unit 24 compares the transaction count of the delayed job operation “B” and the current transaction count of the “job operation: A” mapped to “wp2.” For example, the delay handling control unit 24 compares the transaction count of the job operation “A” stored on the degree of influence storage unit 37 with the transaction count of the job operation “B.” If the transaction count of “A” is lower than the transaction count of “B,” the delay handling control unit 24 in the control operation thereof lowers the priority of the “process: wp1” with respect to the “job operation: B.”

If the “transaction count: 30” of “A” is higher than the “transaction count: 10” of “B” as illustrated in FIG. 21, the delay handling control unit 24 sets the loop disable flag. A plurality of delayed job processes within the detection time band may be stored. In such case, the delay handling control unit 24 in the control operation thereof lowers the priority only if the transaction count of the job operation for all the delayed job processes is lower than the transaction count of the delayed job operation.

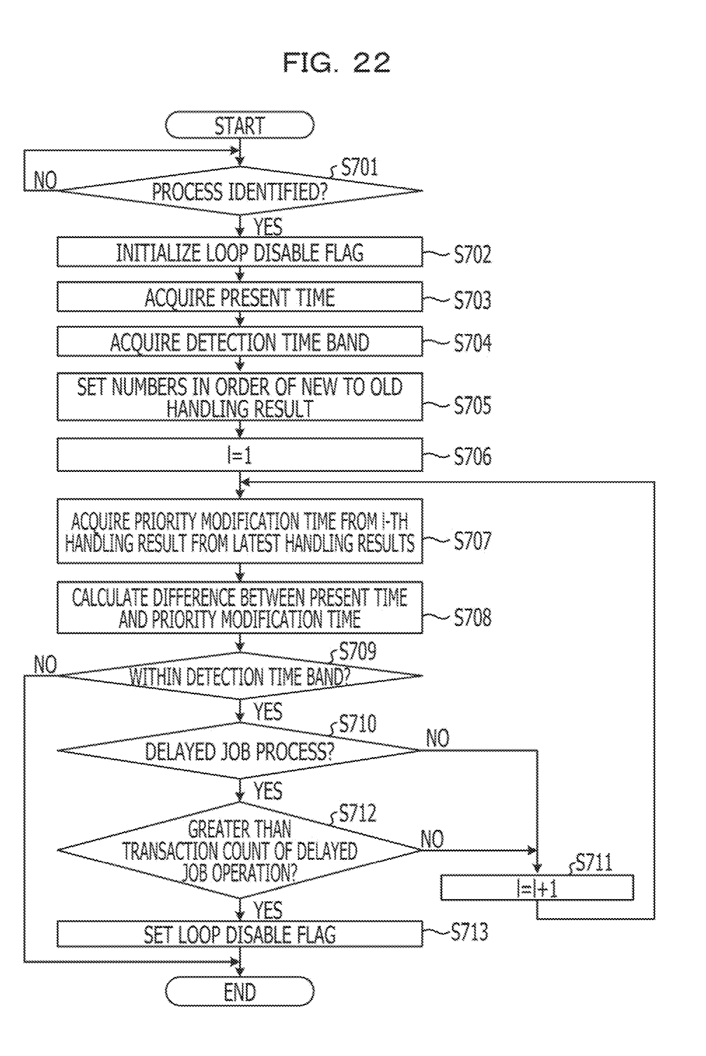

The loop control process executed by the priority control apparatus of the third embodiment is described below with reference to FIG. 22. FIG. 22 is an example flowchart of the loop control process of the third embodiment. S701-S709 in FIG. 22 are respectively similar to S601-S609 in FIG. 19 and the discussion thereof is omitted here.

The process of the priority control apparatus of the third embodiment is similar to the process of the priority control apparatus of the second embodiment discussed with reference to FIG. 14, and the discussion thereof is omitted here. The determination process of the degree of delay of the job operation by the priority control apparatus of the third embodiment is similar to the determination process of the degree of delay of the job operation by the priority control apparatus of the second embodiment discussed with reference to FIG. 15 and the discussion thereof is omitted here. The handling process of the delayed job operation by the priority control apparatus of the third embodiment is similar to the handling process of the delayed job operation by the priority control apparatus of the second embodiment discussed with reference to FIG. 16 and the discussion thereof is omitted here. The first handling of the delayed job operation by the priority control apparatus of the third embodiment is similar to the first handling of the delayed job operation by the priority control apparatus of the second embodiment discussed with reference to FIG. 17, and the discussion thereof is omitted here. The second handling of the delayed job operation by the priority control apparatus of the third embodiment is similar to the second handling of the delayed job operation by the priority control apparatus of the second embodiment discussed with reference to FIG. 18, and the discussion thereof is omitted here.

If the priority control apparatus of the third embodiment identifies a process the priority of which is to be lowered as illustrated in FIG. 22 (yes branch from S701), the delay handling control unit 24 initializes the loop disable flag (at S702). As in S603-S609 of FIG. 19, the delay handling control unit 24 acquires the present time and the detection time band, and determines whether the difference between the present time and the priority modification time of the handling results falls within the detection time band (at S703-S709).

Upon determining at S709 that the difference fails to fall within the detection time band (no branch from S709), the delay handling control unit 24 ends the process thereof. Upon determining at S709 that the difference falls within the detection time band (yes branch from S709), the delay handling control unit 24 determines whether the priority modification process stored on the handling result storage unit 36 is a delayed job process (at S710).

If it is determined at S710 that the priority modification process is not a delayed job process (no branch from S710), the delay handling control unit 24 sets the number l, set for the handling results, to l=l+1 (at S711), and then returns to S707 to acquire the priority modification time from the (l+1)-th handling results.

If it is determined at S710 that the priority modification process is a delayed job process (yes branch from S710), the delay handling control unit 24 determines whether the current transaction count of the job operation mapped to the delayed job process is higher than the transaction count of the delayed job operation (at S712). For example, the delay handling control unit 24 determines whether the transaction count of the delayed job operation in the degree of influence information stored on the degree of influence storage unit 37 is higher than the transaction count of the job operation mapped to the delayed job process.

If it is determined at S712 that the transaction count of the job operation mapped to the delayed job process is not higher than the transaction count of the delayed job operation (no branch from S712), the delay handling control unit 24 returns to S711 to set the number l, set for the handling results, to l=l+1. If it is determined at S712 that the transaction count of the job operation mapped to the delayed job process is higher than the transaction count of the delayed job operation (yes branch from S712), the delay handling control unit 24 sets the loop disable flag (at S713), and ends the process thereof.

In accordance with the third embodiment, the loop control process is performed using the handling results that map the delayed job operation to the priority modification process. The embodiment is not limited to this arrangement. For example, the loop control process may be performed using the handling results that map the delayed job operation to the job operation with the priority thereof modified.

In accordance with the third embodiment, the priority controller 20 identifies the job operation having the number of currently processed jobs higher than that of the delayed job operation if the process executing the currently delayed job operation has the priority thereof lowered. The priority controller 20 then determines whether the priority of the process has been lowered with respect to the identified job operation. If the priority has been lowered, the priority controller 20 in the control operation thereof lowers the priority of the identified process on condition that the specific period of time has elapsed since the lowering of the priority of the process. Even if the handling of the delayed job operation is temporarily restricted through the loop control, the job operation having a low transaction count can be selected, and the effect of delay on the job operation is minimized.

The first through third embodiments have been discussed. A variety of embodiments may be implemented in addition to the first through third embodiments. The variety of embodiments may include the following modifications (1)-(6) to the first through third embodiments.

(1) Shared Job Operation

In accordance with the first through third embodiments, the high shared job operation having a high shared use frequency with the delayed job operation and having a minimum degree of delay is identified, and the priority of the process executing the identified high shared job operation is lowered. The embodiments are not limited to this arrangement. For example, the priority of the process executing the shared job operation sharing the object with the delayed job operation may be lowered without identifying the high shared job operation.

(2) Shared Use Frequency

In accordance with the first through third embodiments, the high shared job operation is identified using the shared use frequency of the object shared in the bottleneck server after the shared use frequency is weighted with a specific weight. The embodiments are not limited to this arrangement. For example, the high shared job operation may be identified using the shared use frequency that has not been weighted with the specific weight.

(3) Loop Control

In accordance with the first through third embodiments, the loop control process is performed when the priority, at which the process of the same high shared job operation is executed on the same delayed job operation, is lowered. The embodiments are not limited to this arrangement. For example, the loop control process may not be performed.

(4) Determination Criteria

In accordance with the first through third embodiments, the average process time is used as determination criteria of the degree of delay of the job operation. The embodiments are not limited to this arrangement. The longest process time or a 85 percentile value may be used.

(5) Communication Path

In accordance with the first through third embodiments, the priority control apparatus is connected to the Web server, the AP server, and the DB server via the network. The embodiments are not limited to this arrangement. For example, the priority control apparatus may be connected to the Web server, the AP server, and the DB server different communication paths.

(6) System Structure

Information including the process procedure, the specific designations, the variety of data, and the variety of parameters described with reference to the embodiments may be updated unless otherwise noted. For example, if a new job operation is added to the job operations performed in the job operation system, the job operation information stored on the job operation information storage unit 31 may be updated as appropriate.

Each element of the apparatuses illustrated above does not necessarily represent a physical structure as illustrated. For example, integration or separation of elements of each apparatus is not limited to a specific configuration (such as the configuration illustrated in FIG. 2). The elements may be partly or wholly, and functionally or physically, integrated or separated depending on workload or use status of the apparatus. For example, the shared use information storage unit 32 and the delay handling information storage unit 35 may be integrated into a single element, or the delay handling control unit 24 may be separated into a priority lowering control unit for lowering the priority and a loop control unit for executing the loop control process. The priority controller 20 may be connected as an external unit to the priority control apparatus 10 via the network 60. The shared use information generator 21 and the delay handling control unit 24 may be respectively included in separate apparatuses connected to the priority control apparatus 10 via the network 60, and the priority control apparatus 10 may perform the function thereof in cooperation with the separate apparatuses. The function of each apparatus may be executed partly or wholly by a CPU or a program that the CPU decodes. Alternatively, the function of each apparatus may be implemented using hardware wired logic.

The processes described above are automatically performed. Part or whole of the processes may be manually performed. For example, the generation and the storage of the shared use information illustrated in FIG. 14 may be manually performed. The process that has been described as being manually performed may be partly or wholly automatically performed using a known technique. For example, the input operation of the monitoring command in FIG. 14 may be manually performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A priority control apparatus, comprising:
a job operation information storage unit which stores, as job operation information on a per job operation basis for a plurality of job operations, a process and an object used by the process with the process mapped to the object, each job operation being executed by a plurality of processes;
a delay determiner which determines a first job operation that is delayed from among the plurality of job operations; and
a priority controller which identifies a second job operation sharing an object used in the first job operation by referencing the job operation information storage unit, identifies a process, using an object not used in the first job operation, from among the processes executing the second job operation identified, and lowers a priority at which the identified process is to be executed.

2. The priority control apparatus according to claim 1, further comprising a handling result storage unit which stores the process having the priority thereof lowered in a control operation and a time of the control operation with the process and the time mapped to each other,
wherein when the identified process is stored on the handling result storage unit, the priority controller lowers the priority of the identified process on condition that a specific period of time has elapsed since the time of the lowering of the priority.

3. The priority control apparatus according to claim 1, further comprising a handling result storage unit which stores the process having the priority thereof lowered in the control operation,
wherein when the process executing the first job operation is stored on the handling result storage unit, the priority controller identifies a third job operation with a transaction count higher than a transaction count of the first job operation, determines whether a priority of a process executing the third job operation has been lowered, and when the priority of the process executing the third job operation has been lowered, lowers the priority of the execution of the identified process on condition that a specific period of time has elapsed since the time the priority of the identified process was previously lowered.

4. The priority control apparatus according to claim 1, further comprising a shared use information storage unit for storing, as shared use information, a shared use frequency of an object shared by two job operations, wherein
the delay determiner determines a degree of delay occurring in the job operation; and
the priority controller identifies, by referencing the shared used information storage unit, the second job operation having a high shared use frequency with the first job operation and having a minimum degree of delay determined by the delay determiner, identifies a process using an object not used in the first job operation, from among the processes executing the identified second job operation, and lowers the priority of the identified process.

5. The priority control apparatus according to claim 4, wherein
the shared use information storage unit stores the shared use frequency of the shared use information and an execution area where the process is executed, with the shared use frequency and the execution area mapped to each other;
the delay determiner determines a cause area serving as a main cause for a delay from among a plurality of execution areas where the process of the first job operation is performed; and
the priority controller identifies from the shared use information storage unit a shared use frequency of an object used by the process executed in the cause area and shared with the first job operation, identifies the second job operation by referencing the shared use information having the identified shared use frequency weighted with a specific weight, identifies a process using an object not used in the first job operation, from among the processes executing the second job operation, and lowers the priority of the identified process.

6. The priority control apparatus according to claim 4, wherein
the delay determiner sorts job operations other than the delayed job operation into a first group having a degree of delay falling within a tolerance range, and a second group free from delay; and
the priority controller lowers in the second job operation the priority of the process using an object not used in the first job operation when the second job operation is included in the second group, identifies a third job operation sharing an object used in the second job operation by referencing the job operation information stored on the job operation information storage unit when the second job operation is included in the first group, and lowers in the third job operation the priority of the process using an object not used in the second job operation.

7. A priority control method, comprising:
determining, using a processor, a first job operation that is delayed from among a plurality of job operations, each job operation being executed by a plurality of processes; and
first identifying, using the processor, a second job operation sharing an object used in the first job operation by referencing a first storage unit, the first storage unit storing, as job operation information on a per job operation basis for a plurality of job operations, a process executing the job operation and an object used by the process with the process mapped to the object;
second identifying, using the processor, a process, using an object not used in the first job operation, from among the processes executing the second job operation; and
lowering, using the processor, a priority at which the identified process is to be executed.

8. The priority control method according to claim 7, further comprising:
storing on a second storage unit the process having the priority thereof lowered in a control operation and a time of the control operation with the process and the time being mapped to each other, wherein
when the identified process is stored on the second storage unit, the lowering lowers the priority of the identified process on condition that a specific period of time has elapsed since the time of the lowering of the priority.

9. The priority control method according to claim 7, further comprising:
storing on a second storage unit the process having the priority thereof lowered in a control operation and a time of the control operation with the process and the time mapped to each other; and
when the process executing the first job operation is stored on the second storage unit, third identifying a third job operation with a transaction count higher than a transaction count of the first job operation, determining whether a priority of a process executing the third job operation has been lowered, wherein
when the priority of the process executing the third job operation has been lowered, lowering the priority of the execution of the identified process on condition that a specific period of time has elapsed since the time of the priority of the identified process was previously lowered.

10. The priority control method according to claim 7, wherein the determining determines the degree of delay in the job operation; and
the first identifying identifies, by referencing a second storage unit, the second storage unit storing the shared use frequency of an object shared by the two operations, the second job operation having a high shared use frequency with the first job operation and having a minimum degree of delay.

11. The priority control method according to claim 10, wherein
the shared use frequency and information of an execution area where the process is executed are stored on the second storage unit with the shared use frequency and the execution area mapped to each other;
the determining determines a cause area serving as a main cause for a delay from among a plurality of execution areas where the process of the first job operation is executed; and
the first identifying identifies from the second storage unit a shared use frequency of an object used by the process executed in the cause area and shared with the first job operation, and identifies the second job operation by referencing the shared use information having the identified shared use frequency weighted with a specific weight.

12. The priority control method according to claim 7, further comprising:
sorting job operations other than the delayed job operation into a first group having a degree of delay falling within a tolerance range, and a second group free from delay; and
identifying a third job operation sharing an object used in the first group by referencing the first storage unit if the second job operation is included in the first group, wherein
the lowering lowers in the second job operation the priority of the process using an object not used in the first job operation when the second job operation is included in the second group and lowers in the third job operation the priority of the process using an object not used in the second job operation when the second job operation is included in the first group.
